(19) United States
(12) Patent Application Publication
(10) Pub. No.: US 2025/0274550 A1
(43) Pub. Date: Aug. 28, 2025

(54) IMAGE FORMING APPARATUS, IMAGE FORMING METHOD, AND RECORDING MEDIUM

(71) Applicant: CANON KABUSHIKI KAISHA, Tokyo (JP)

(72) Inventor: YUMA IKEUCHI, Kanagawa (JP)

(21) Appl. No.: 19/061,575

(22) Filed: Feb. 24, 2025

(30) Foreign Application Priority Data
Feb. 26, 2024 (JP) 2024-026123

(51) Int. Cl. H04N 1/00; G06V 30/12; G06V 30/244; H04N 1/32

(52) U.S. Cl. CPC H04N 1/00331; G06V 30/133; G06V 30/2445; H04N 1/32122

(57) ABSTRACT

In a case where a single image is formed by reading one or more reading sheets multiple times, and if the reading sheets are not appropriately placed on a document platen, images of the plurality of reading sheets formed in the single image do not match each other in up, down, left, and right or vertical and horizontal relationships desired by a user. An image forming apparatus includes a display unit configured to, based on a direction of a character string obtained from an image obtained by reading a first surface and a direction of a character string obtained from an image obtained by reading a second surface, display information regarding whether a direction of a reading sheet relative to a predetermined reference is excellent or poor.

### BACKGROUND

### Field of the Disclosure

The present disclosure relates to an image forming apparatus, an image forming method, and a recording medium.

### Description of the Related Art

In a case where a reading sheet is read in an image forming apparatus, there is a case where the reading sheet is placed at a predetermined location (e.g., on a document platen) of the image forming apparatus, and a reading operation is performed (the reading sheet is scanned) (Japanese Patent Application Laid-Open No. 2009-100102).

In the above technique, in a case where a single image is formed by reading one or more reading sheets multiple times, and if the reading sheets are not appropriately placed on the document platen, images of the plurality of reading sheets formed in the single image may not match each other in up, down, left, and right or vertical and horizontal relationships desired by a user.

### SUMMARY

The present disclosure is directed to, in a case where a single image is formed by reading one or more reading sheets multiple times, and even if the reading sheets are not appropriately placed on a document platen, causing images of the plurality of reading sheets formed in the single image to match each other in up, down, left, and right or vertical and horizontal relationships desired by a user.

According to an aspect of the present disclosure, an image forming apparatus includes a reading unit including a document platen, the reading unit configured to read one or more reading sheets each including a first surface and a second surface, an image forming unit configured to form a single image based on images obtained by reading the first surface and the second surface, and a display unit configured to, based on a direction of a character string obtained from the image obtained by the reading unit reading the first surface and a direction of a character string obtained from the image obtained by the reading unit reading the second surface, display information regarding whether a direction of the reading sheet relative to a predetermined reference is excellent or poor.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of an image forming apparatus according to one or more aspects of the present disclosure.

FIG. 2 is a diagram illustrating a software configuration of the image forming apparatus according to one or more aspects of the present disclosure.

FIGS. 3A and 3B are a diagram illustrating a flowchart of an identification (ID) card copying process according to one or more aspects of the present disclosure.

FIG. 4 is a diagram illustrating an “ID card copying” screen according to one or more aspects of the present disclosure.

FIG. 5 is diagrams illustrating images obtained by a scanner reading ID cards placed on a document platen according to one or more aspects of the present disclosure.

FIGS. 6A and 6B are diagrams illustrating warning screens according to one or more aspects of the present disclosure.

FIG. 7 is a diagram illustrating a flowchart of an ID card copying warning settings update process according to one or more aspects of the present disclosure.

FIGS. 8A to 8C are diagrams illustrating screens regarding updates to ID card copying warning settings according to one or more aspects of the present disclosure.

FIGS. 9A and 9B are a diagram illustrating a flowchart of an ID card copying process according to one or more aspects of the present disclosure.

FIGS. 10A and 10B are a diagram illustrating a flowchart of an ID card copying process according to one or more aspects of the present disclosure.

FIG. 11 is diagrams illustrating ID card placement error warning screens according to one or more aspects of the present disclosure.

FIGS. 12A and 12B are a diagram illustrating a flowchart of an ID card copying process according to one or more aspects of the present disclosure.

FIG. 13 is diagrams illustrating ID card character recognition failure screens according to one or more aspects of the present disclosure.

FIGS. 14A and 14B are a diagram illustrating a flowchart of an ID card copying process according to one or more aspects of the present disclosure.

FIGS. 15A and 15B are a diagram illustrating a flowchart of an ID card copying process according to one or more aspects of the present disclosure.

FIG. 16 is a diagram illustrating an “ID card copying” screen according to one or more aspects of the present disclosure.

FIG. 17 is a diagram illustrating images obtained by a scanner reading an ID card according to one or more aspects of the present disclosure.

FIG. 18 is a diagram illustrating the images obtained by the scanner reading the ID card according to one or more aspects of the present disclosure.

FIG. 19 is a diagram illustrating the images obtained by the scanner reading the ID card according to one or more aspects of the present disclosure.

FIG. 20 is a diagram illustrating a flowchart of an ID card copying process according to one or more aspects of the present disclosure.

### DESCRIPTION OF THE EMBODIMENTS

With reference to the drawings, exemplary embodiments for carrying out the present disclosure will be described in detail in an illustrative manner below. Components described in the exemplary embodiments, however, are merely illustrative, and are not intended to limit the scope of the present disclosure to them only.

In the following exemplary embodiments, for example, a reading sheet is a single identification (ID) card, a front surface is a first surface, a back surface is a second surface, the front surface is a first reading sheet, and the back surface is a second reading sheet.

The reading sheet may be a plurality of sheets. Unless otherwise stated, a predetermined reference is a document platen of an image forming apparatus, and for example, information regarding whether the direction of the reading sheet relative to the document platen is excellent or poor is displayed using the following correct answer pattern information (correct answer patterns).

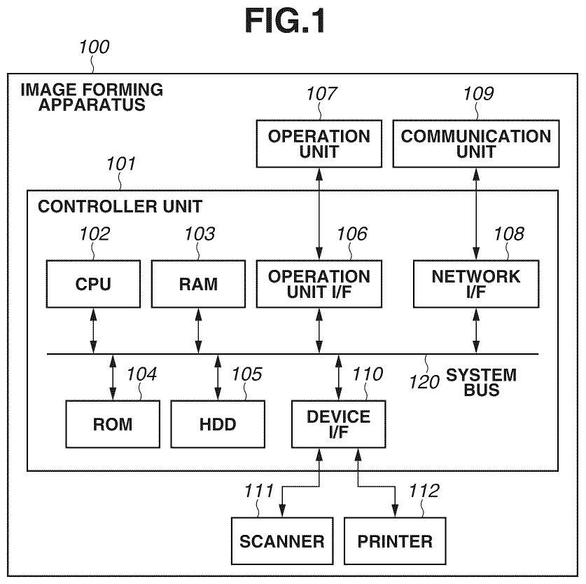

FIG. 1 is a block diagram illustrating the hardware configuration of an image forming apparatus 100 according to a first exemplary embodiment.

The image forming apparatus 100 includes a controller unit 101. The controller unit 101 controls a scanner 111, a printer 112, an operation unit 107, and a communication unit 109. In a case where a user uses a copy function, the controller unit 101 controls the scanner 111 to acquire image data on a document and controls the printer 112 to print the image on a sheet and output the image. In a case where the user uses a scan function, the controller unit 101 controls the scanner 111 to acquire image data on a document and convert the image data into code data. Then, the controller unit 101 transmits the code data to an external apparatus (not illustrated) via the communication unit 109.

An instruction to execute the processing of each of these functions is referred to as a “job”. The image forming apparatus 100 executes predetermined processing according to a job corresponding to each function.

The controller unit 101 includes a central processing unit (CPU) 102, a random-access memory (RAM) 103, a read-only memory (ROM) 104, a hard disk drive (HDD) 105, an operation unit interface (I/F) 106, a network I/F 108, and a device I/F 110. These components are connected to each other by a system bus 120.

The CPU 102 controls the entirety of the system of the image forming apparatus 100. The RAM 103 is a system work memory for the operation of the CPU 102 and is an image memory for temporarily storing image data. In the RAM 103, an operating system, programs such as system software and application software, and data are also placed.

The RAM 103 also stores scanned image data read by the scanner 111 and stores print data received via a network. The ROM 104 stores a boot program for the system. The HDD 105 stores an operating system, system software, application software, print data, and setting data.

The operation unit I/F 106 is an interface unit with the operation unit 107 and outputs information to be displayed on the operation unit 107 to the operation unit 107. The operation unit I/F 106 also receives information input by the user from the operation unit 107. The network I/F 108 is connected to the communication unit 109 and controls various types of communication with an external apparatus.

The device I/F 110 connects the scanner 111 and the printer 112 that read and print image data and the controller unit 101, and inputs and outputs the image data. The scanner 111 includes a document platen. The scanner 111 detects the sheet size of a document set on the document platen and reads the document set on the document platen, thereby forming image data.

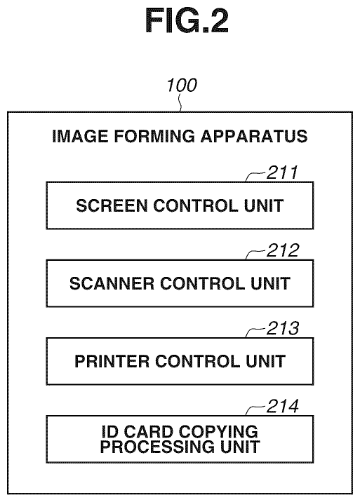

FIG. 2 is a block diagram illustrating the software configuration of the image forming apparatus 100 according to the present exemplary embodiment. The blocks in FIG. 2 are software stored in the ROM 104 or the HDD 105, and processing in flowcharts described below are achieved by the CPU 102 reading the software into the RAM 103 and executing the software.

A screen control unit 211 controls the operation unit 107 through the operation unit I/F 106. The screen control unit 211 receives information input through the operation unit 107 by the user, or forms a screen to be displayed on the operation unit 107. A scanner control unit 212 controls the scanner 111 through the device I/F 110 to read a document placed on the document platen, thereby forming image data. A printer control unit 213 controls the printer 112 through the device I/F 110 to print image data on a sheet and output the image data.

An ID card copying processing unit 214 performs processing for achieving an ID card copying function. Based on the settings of ID card copying, the ID card copying processing unit 214 performs an optical character recognition (OCR) analysis of front surface image data and back surface image data of an ID card, thereby determining the directions of character strings on the front surface image data and back surface image data. The ID card copying processing unit 214 also aggregates the image data, thereby forming print data. The ID card copying processing unit 214 also holds correct answer pattern information regarding the front surface and the back surface of an ID card as inside information. Table 1 illustrates the correct answer pattern information according to the present exemplary embodiment.

TABLE 1
Correct Answer Pattern Information

| | Front Surface Character | Back Surface Character |
|---|---|---|
| ID | String Direction | String Direction |
| Pattern001 | Rightward | Rightward |
| Pattern002 | Rightward | Upward |
| Pattern003 | Rightward | Downward |
| Pattern004 | Upward | Upward |
| Pattern005 | Upward | Rightward |
| Pattern006 | Downward | Downward |
| Pattern007 | Downward | Rightward |

“ID” is an attribute indicating a value for uniquely identifying correct answer pattern information. “Front surface character string direction” is an attribute indicating a correct answer to the direction of a character string on the front surface of an ID card. For example, “rightward” means that the character string on the front surface of the ID card is written from left to right. “Back surface character string direction” is an attribute indicating a correct answer to the direction of a character string on the back surface of the ID card. For example, correct answer pattern information of which “ID” is “Pattern002” indicates that a correct answer is a pattern where a character string on the front surface of an ID card is directed from left to right and a character string on the back surface of the ID card is directed from bottom to top.

In the present exemplary embodiment, the correct answer patterns (the correct answer pattern information) (a pattern table) are held as inside information regarding the ID card copying processing unit 214. The present disclosure, however, is not particularly limited to this configuration. For example, a form may be employed in which the correct answer pattern information is stored in the HDD 105, and the ID card copying processing unit 214 refers to the information in the HDD 105.

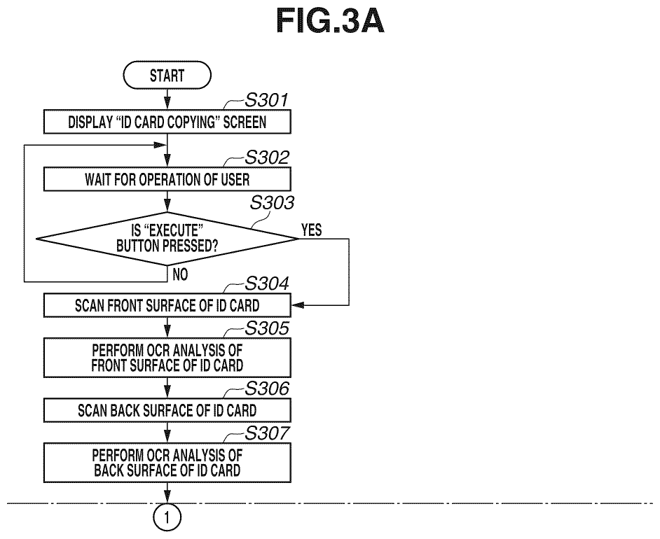

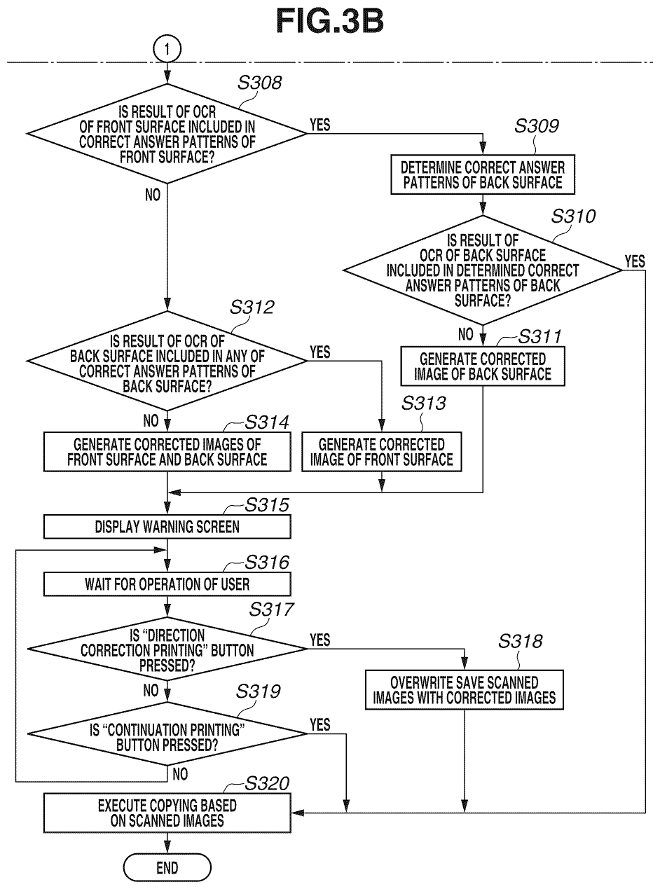

FIGS. 3A and 3B are a flowchart for describing the processing of the ID card copying function executed by the image forming apparatus 100 according to the present exemplary embodiment. The flowchart in FIGS. 3A and 3B is achieved by the CPU 102 of the image forming apparatus 100 reading the programs for achieving the software modules stored in the ROM 104 or the HDD 105 into the RAM 103 and executing the programs.

Although in the present exemplary embodiment, the ID card copying function is configured as an independent application, this is merely an example, and the present disclosure is not limited to this. For example, the ID card copying function may be prepared as a function of a copy application.

In step S301, the screen control unit 211 receives an instruction to perform an ID card copying process from the user, starts an ID card copying application, and displays an “ID card copying” screen.

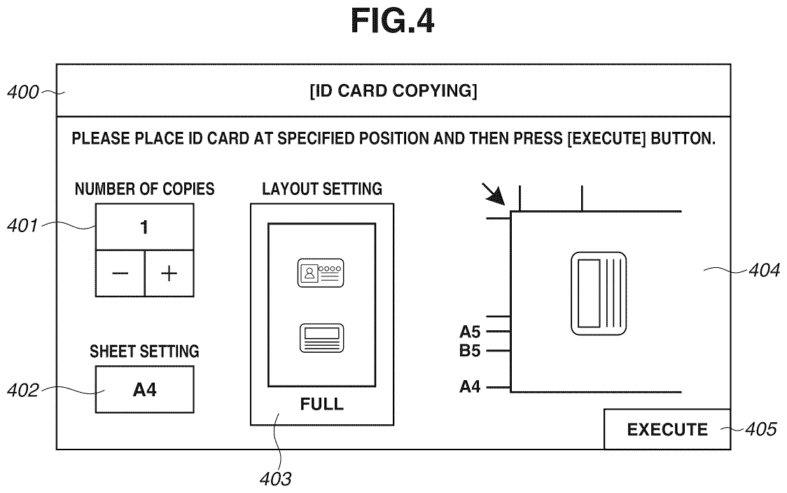

With reference to FIG. 4, the “ID card copying” screen is described.

FIG. 4 illustrates an example of the “ID card copying” screen displayed on the operation unit 107.

An “ID card copying” screen 400 includes a number-of-copies setting 401, a sheet size setting 402, a layout setting 403, a guide display 404, and an “execute” button 405. The number-of-copies setting 401 is a component for displaying and making the setting of the number of copies to be printed. The user changes the setting of the number of copies to be printed using a “+” button and a “−” button. The sheet size setting 402 is a component for displaying and making the setting of the print sheet size. The sheet size setting 402 is in the form of a button, and a screen for selecting the print sheet size (not illustrated) is displayed by pressing the button.

The layout setting 403 is a component for displaying and making the setting of how to lay out the front and the back of an ID card on a print sheet. The layout setting 403 is in the form of button, and a screen for selecting the layout setting (not illustrated) is displayed by pressing the button. The guide display 404 is a display for describing at which position on the document platen the ID card is to be placed.

The “execute” button 405 is a button for giving an instruction to start executing the ID card copying function.

The description returns to FIGS. 3A and 3B.

In step S302, the ID card copying processing unit 214 waits for an operation of the user through the screen control unit 211. In step S303, the ID card copying processing unit 214 analyzes an operation of the user through the screen control unit 211 and determines whether the “execute” button 405 in FIG. 4 is pressed. At this time, if it is determined that the “execute” button 405 is pressed (Yes in step S303), the processing proceeds to step S304. If it is determined that the “execute” button 405 is not pressed (No in step S303), the processing returns to step S302.

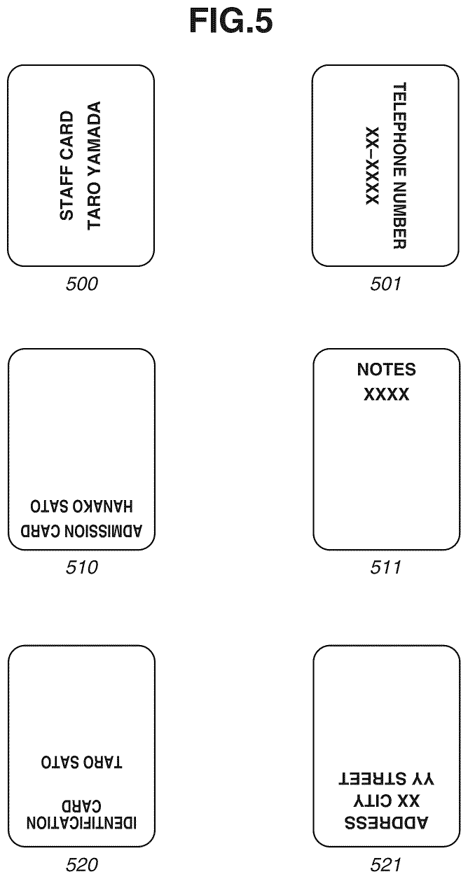

In step S304, the ID card copying processing unit 214 scans the front surface of an ID card using the scanner 111 through the scanner control unit 212, forms a scanned image, and temporarily stores the scanned image in the RAM 103. At this time, the scanning is performed on an ID card set on the document platen of the image forming apparatus 100 by the user. With reference to FIG. 5, examples of the scanned image formed by the scanner 111 reading the ID card set on the document platen by the user are described.

A staff card front surface image 500 is an example of a scanned image formed by the scanner 111 reading the front surface of a staff card set on the document platen by the user. In the staff card front surface image 500, a character string is written upward in vertical writing.

A staff card back surface image 501 is a back surface image of the staff card front surface image 500. In the staff card back surface image 501, a character string is written in vertical writing, which is the same as the staff card front surface image 500, but is written downward. Thus, it is understood that the user sets the staff card on the document platen by reversing left and right.

An admission card front surface image 510 is an example of a scanned image formed by the scanner 111 reading the front surface of an admission card set on the document platen by the user. In the admission card front surface image 510, a character string is written leftward in horizontal writing. Thus, it is understood that the user sets the admission card on the document platen by reversing top and bottom.

An admission card back surface image 511 is a back surface image of the admission card front surface image 510. In the admission card back surface image 511, a character string is written in horizontal writing, which is the same as the admission card front surface image 510, but is written rightward. Thus, in the admission card back surface image 511, it is understood that the user sets the admission card on the document platen in a correct direction. An identification card front surface image 520 is an example of a scanned image formed by the scanner 111 reading the front surface of an identification card set on the document platen by the user.

In the identification card front surface image 520, a character string is written leftward in horizontal writing. Thus, it is understood that the user sets the identification card on the document platen by reversing top and bottom. An identification card back surface image 521 is a back surface image of the identification card front surface image 520. In the identification card back surface image 521, a character strings is written in horizontal writing, which is the same as the identification card front surface image 520, and is written leftward. Thus, also in the identification card back surface image 521, it is understood that the user sets the identification card on the document platen by reversing top and bottom.

In the present exemplary embodiment, three users, namely a user A who is the owner of the staff card, a user B who is the owner of the admission card, and a user C who is the owner of the identification card, each execute the ID card copying function.

The user A scans the staff card front surface image 500 and the staff card back surface image 501 and sets the staff card on the document platen by reversing the left and right of the back surface. The user B scans the admission card front surface image 510 and the admission card back surface image 511 and sets the admission card on the document platen by reversing the top and bottom of the front surface.

The user C scans the identification card front surface image 520 and the identification card back surface image 521 and sets the identification card on the document platen by reversing the top and bottom of both the front surface and the back surface.

The description returns to FIGS. 3A and 3B.

In step S305, the ID card copying processing unit 214 performs an OCR analysis of the scanned image of the front surface of the ID card formed in step S304 from two horizontal directions and two vertical directions. After that, the ID card copying processing unit 214 determines the direction in which the recognition rate of characters with a language setting set in advance in the image forming apparatus 100 is the highest, and determines this direction as the direction of characters on the front surface of the ID card.

For example, as a result, in the staff card front surface image 500, the character recognition rate of the OCR analysis from the horizontal right direction is high, but the character recognition rates of the OCR analysis from the other directions are extremely low. Thus, in the staff card front surface image 500, it is determined that characters are written upward. By this technique, in both the admission card front surface image 510 and the identification card front surface image 520, it is determined that characters are written leftward. Although in the present exemplary embodiment, the direction of a character string written on the ID card is determined by the above technique, this is merely an example. The technique for determining the direction of a character string written in a scanned image is not particularly limited.

In step S306, similarly to step S304, the ID card copying processing unit 214 scans the back surface of the ID card using the scanner 111 through the scanner control unit 212, forms a scanned image, and temporarily stores the scanned image in the RAM 103. In step S307, similarly to step S305, the ID card copying processing unit 214 performs an OCR analysis of the scanned image of the back surface of the ID card formed in step S306 and determines the direction of characters on the back surface of the ID card. In the staff card back surface image 501, it is determined that characters are written downward. In the admission card back surface image 511, it is determined that characters are written rightward. In the identification card back surface image 521, it is determined that characters are written leftward.

In step S308, the ID card copying processing unit 214 determines whether the direction of the character string on the front surface of the ID card determined in step S305 is included in correct answer patterns of the front surface. Specifically, the ID card copying processing unit 214 determines whether correct answer information that matches any of the values of the “front surface character string direction” attribute in the correct answer pattern information in table 1 is present. At this time, if it is determined that correct answer information is present (Yes in step S308), the processing proceeds to step S309. If it is determined that correct answer information is not present (No in step S308), the processing proceeds to step S312. In the present exemplary embodiment, the character string in the staff card front surface image 500 of the user A is upward and corresponds to “Pattern004” and “Pattern005”.

Thus, in the case of the user A, the processing proceeds to step S309. The character string in the admission card front surface image 510 of the user B is leftward, and corresponding correct answer pattern information is not present. Thus, in the case of the user B, the processing proceeds to step S312. The character string in the identification card front surface image 520 of the user C is leftward, and corresponding correct answer pattern information is not present. Thus, in the case of the user C, the processing proceeds to step S312.

In step S309, the ID card copying processing unit 214 determines all the values of “back surface character string direction” in the correct answer pattern information that the correct answer information matches according to the determination in step S308 as correct answer patterns of the back surface. In the present exemplary embodiment, “upward” and “rightward” as “back surface character string direction” of “Pattern004” and “Pattern005”, which match the staff card front surface image 500 of the user A, are the correct answer patterns of the back surface.

In step S310, the ID card copying processing unit 214 determines whether the character string on the back surface of the ID card determined in step S307 is included in the correct answer patterns of the back surface determined in step S309. At this time, if it is determined that the character string is included in the correct answer patterns (Yes in step S310), it is determined that the user scans the ID card in a correct direction. Then, the processing proceeds to step S320.

If it is determined that the character string is not included in the correct answer patterns (No in step S310), the processing proceeds to step S311. In the present exemplary embodiment, the character string in the staff card back surface image 501 of the user A is downward, and is not included in the correct answer patterns of the back surface determined in step S309. Thus, in the case of the user A, the processing proceeds to step S311.

In step S311, the ID card copying processing unit 214 forms a corrected image obtained by rotating the scanned image of the back surface of the ID card temporarily stored in step S306 to match the direction of the character string on the front surface of the ID card and temporarily stores the corrected image in the RAM 103. For example, in the present exemplary embodiment, the character string in the staff card front surface image 500 of the user A is upward, and the character string in the staff card back surface image 501 is downward. Thus, a corrected image obtained by rotating the back surface by 180° is formed. In step S312, the ID card copying processing unit 214 determines whether the direction of the character string on the back surface of the ID card determined in step S307 is included in any of correct answer patterns of the back surface.

Specifically, the ID card copying processing unit 214 determines whether correct answer information that matches any of the values of the “back surface character string direction” attribute in the correct answer pattern information in table 1 is present. At this time, if it is determined that correct answer information is present (Yes in step S312), the processing proceeds to step S313. If it is determined that correct answer information is not present (No in step S312), the processing proceeds to step S314.

In the present exemplary embodiment, the character string in the admission card back surface image 511 of the user B is rightward and corresponds to “Pattern001”, “Pattern005”, and “Pattern007”. Thus, in the case of the user B, the processing proceeds to step S313. The character string in the identification card back surface image 521 of the user C is leftward, and corresponding correct answer pattern information is not present. Thus, in the case of the user C, the processing proceeds to step S314.

In step S313, the ID card copying processing unit 214 forms a corrected image obtained by rotating the scanned image of the front surface of the ID card temporarily stored in step S304 to match the direction of the character string on the back surface of the ID card and temporarily stores the corrected image in the RAM 103.

For example, in the present exemplary embodiment, the character string in the admission card back surface image 511 of the user B is rightward, and the character string in the admission card front surface image 510 is leftward. Thus, a corrected image obtained by rotating the front surface by 180° is formed. In step S314, the ID card copying processing unit 214 forms corrected images obtained by reversing the scanned images of the front surface of the ID card temporarily stored in step S304 and the back surface of the ID card temporarily stored in step S306 and temporarily stores the corrected images in the RAM 103.

For example, in the present exemplary embodiment, the character strings in the identification card front surface image 520 and the identification card back surface image 521 of the user C are leftward. Thus, corrected images obtained by rotating the front surface and the back surface by 180° are formed.

In step S315, the ID card copying processing unit 214 displays a warning screen (the state where information regarding whether the reading result of the ID card is excellent or poor indicates poor) through the screen control unit 211. The warning screen is displayed only if it is determined that the user scans either or both of the front surface and the back surface of the ID card in incorrect directions. Thus, if it is determined in steps S308 and S310 that the directions of the character strings on the ID card are included in the correct answer patterns of the front surface and the back surface, the warning screen is not displayed (the state where the information regarding whether the reading result of the ID card is excellent or poor indicates excellent).

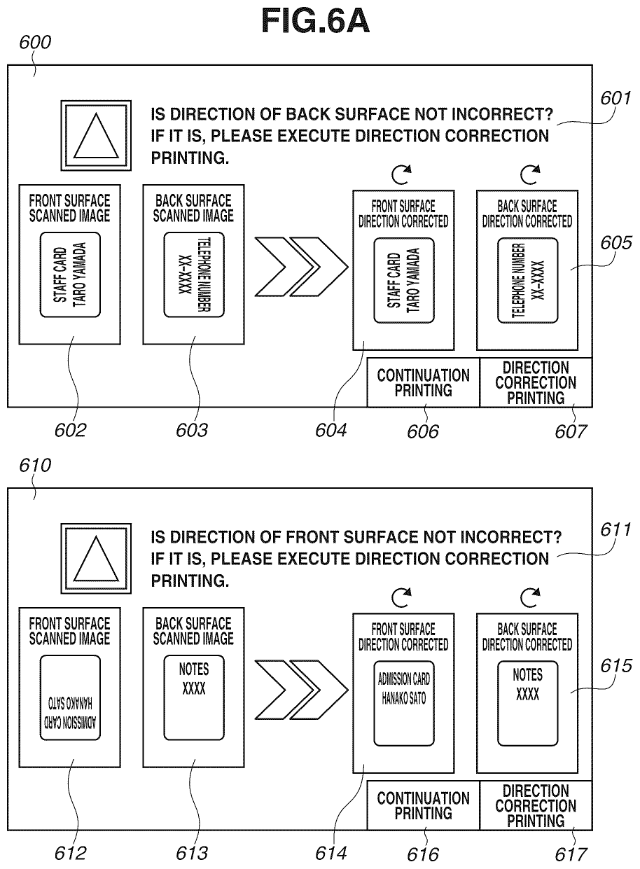

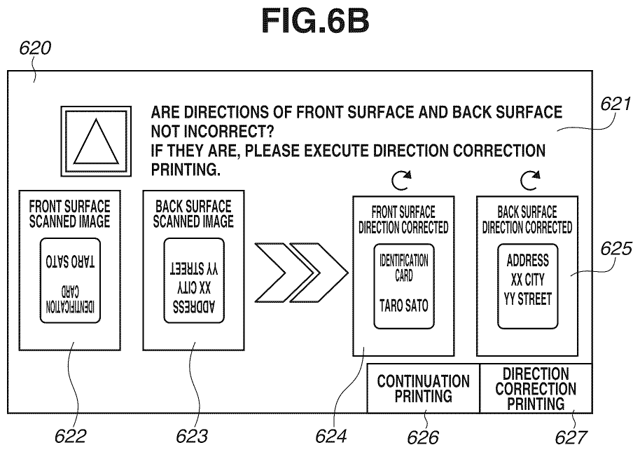

With reference to FIGS. 6A and 6B, the warning screen is described.

FIGS. 6A and 6B illustrate examples of the warning screen displayed on the operation unit 107.

A warning screen 600 includes a warning display 601, a “front surface scanned image” display 602, a “back surface scanned image” display 603, a “front surface direction corrected image” display 604, a “back surface direction corrected image” display 605, a “continuation printing” button 606, and a “direction correction printing” button 607. In the present exemplary embodiment, the warning screen 600 is a warning screen when the user A scans the staff card.

The warning display 601 is an area that displays a notification indicating that there is a possibility that the user places the back surface of the ID card in an incorrect direction, and a message suggesting performing direction correction printing as needed. If the corrected image formed in step S311 or S313 or the corrected images formed in step S314 are present in the RAM 103, a warning according to the surface of the corrected image that is present or the surfaces of the corrected images that are present is displayed. In the present exemplary embodiment, since the corrected image of the staff card back surface image 501 of the user A is present, a notification indicating that there is a possibility that the direction of the back surface is incorrect is given.

The “front surface scanned image” display 602 is an area that displays the scanned image of the front surface of the ID card saved in the RAM 103. In the present exemplary embodiment, the staff card front surface image 500 of the user A is displayed.

The “back surface scanned image” display 603 is an area that displays the scanned image of the back surface of the ID card saved in the RAM 103. In the present exemplary embodiment, the staff card back surface image 501 of the user A is displayed. The “front surface direction corrected image” display 604 is an area that displays a corrected image of the front surface of the ID card saved in the RAM 103.

If the corrected image is not present, the scanned image of the front surface of the ID card is displayed. In the present exemplary embodiment, since a corrected image of the staff card front surface image 500 of the user A is not formed, the staff card front surface image 500 is displayed. By operating a rotation icon above the “front surface direction corrected image” display 604, the user can also rotate the front surface direction corrected image and update the corrected image of the front surface of the ID card saved in the RAM 103.

The “back surface direction corrected image” display 605 is an area that displays a corrected image of the back surface of the ID card saved in the RAM 103. If the corrected image is not present, the scanned image of the back surface of the ID card is displayed. In the present exemplary embodiment, since the corrected image of the staff card back surface image 501 of the user A is formed, the corrected image of the staff card back surface image 501 is displayed. By operating a rotation icon above the “back surface direction corrected image” display 605, the user can also rotate the back surface direction corrected image and update the corrected image of the back surface of the ID card saved in the RAM 103.

The “continuation printing” button 606 is a button for giving an instruction to execute ID card copying printing without making direction correction, and ID card copying is executed using the images in the “front surface scanned image” display 602 and the “back surface scanned image” display 603. The “direction correction printing” button 607 is a button for giving an instruction to execute ID card copying printing by making direction correction, and ID card copying is executed using the images in the “front surface direction corrected image” display 604 and the “back surface direction corrected image” display 605.

A warning screen 610 is a warning screen when the user B scans the admission card.

In a warning display 611, since the corrected image of the admission card front surface image 510 of the user B is present, a notification indicating that there is a possibility that the direction of the front surface is incorrect is given.

In a “front surface scanned image” display 612, the admission card front surface image 510 of the user B is displayed. In a “back surface scanned image” display 613, the admission card back surface image 511 of the user B is displayed. In a “front surface direction corrected image” display 614, since the corrected image of the admission card front surface image 510 is present, the corrected image of the admission card front surface image 510 is displayed. In a “back surface direction corrected image” display 615, since a corrected image of the admission card back surface image 511 is not present, the admission card back surface image 511 is displayed.

Components 616 and 617 are similar to the components 606 and 607, respectively, and therefore are not described.

A warning screen 620 is a warning screen when the user C scans the identification card.

In a warning display 621, since the corrected image of the identification card front surface image 520 and the corrected image of the identification card back surface image 521 of the user C are present, a notification indicating that there is a possibility that the directions of the front surface and the back surface are incorrect is given.

In a “front surface scanned image” display 622, the identification card front surface image 520 of the user C is displayed.

In a “back surface scanned image” display 623, the identification card back surface image 521 of the user C is displayed. In a “front surface direction corrected image” display 624, since the corrected image of the identification card front surface image 520 is present, the corrected image of the identification card front surface image 520 is displayed. In a “back surface direction corrected image” display 625, since the corrected image of the identification card back surface image 521 is present, the corrected image of the identification card back surface image 521 is displayed.

Components 626 and 627 are similar to the components 606 and 607, respectively, and therefore are not described.

The description returns to FIGS. 3A and 3B.

In step S316, the ID card copying processing unit 214 waits for an operation of the user through the screen control unit 211. In step S317, the ID card copying processing unit 214 analyzes an operation of the user through the screen control unit 211 and determines whether the “direction correction printing” button 607, 617, or 627 in FIGS. 6A and 6B is pressed. At this time, if it is determined that the “direction correction printing” button 607, 617, or 627 is pressed (Yes in step S317), the processing proceeds to step S318. If it is determined that the “direction correction printing” button 607, 617, or 627 is not pressed (No in step S317), the processing proceeds to step S319.

In step S318, the ID card copying processing unit 214 overwrite saves the image of the front surface of the ID card and the image of the back surface of the ID card stored in the RAM 103 with the corrected images of the front surface and the back surface, respectively, stored in the RAM 103. In step S319, the ID card copying processing unit 214 analyzes an operation of the user through the screen control unit 211 and determines whether the “continuation printing” button 606, 616, or 626 in FIGS. 6A and 6B is pressed. At this time, if it is determined that the “continuation printing” button 606, 616, or 626 is pressed (Yes in step S319), the processing proceeds to step S320. If it is determined that the “continuation printing” button 606, 616, or 626 is not pressed (No in step S319), the processing returns to step S316.

In step S320, the ID card copying processing unit 214 prints and outputs the image of the front surface of the ID card and the image of the back surface of the ID card stored in the RAM 103 through the printer 112.

In the printing and output, the ID card copying processing unit 214 transmits the setting values of the number-of-copies setting 401, the sheet size setting 402, and the layout setting 403 to the printer 112, the printer 112 performs printing according to the settings, and the flowchart ends.

As described above, based on the flowchart in FIGS. 3A and 3B, the user A who scans the staff card back surface image 501 by reversing left and right can notice an error in the placement of the staff card on the warning screen 600. The user B who scans the admission card front surface image 510 by reversing top and bottom can also notice an error in the placement of the admission card on the warning screen 610. The user C who scans the identification card front surface image 520 and the identification card back surface image 521 by reversing top and bottom can also notice errors in the placement of the identification card on the warning screen 620. Further, each user performs direction correction printing and thereby can perform printing in a correct direction without performing ID card copying again.

As described above, according to the present exemplary embodiment, in the ID card copying function of the image forming apparatus, even if the user places the front surface and the back surface of a card in incorrect directions, it is possible to present errors in the placement to the user with high accuracy. Consequently, it is possible to prevent rework caused by performing ID card copying again and prevent unnecessary printing.

In the first exemplary embodiment, a form has been provided in which correct answer pattern information regarding an ID card determined in advance is held, and it is determined whether the front surface and the back surface of a scanned ID card match the correct answer pattern information, thereby detecting errors in the placement of the front surface and the back surface.

However, in an ID card in a user environment where a character string on the back surface does not need to be checked or a user environment where a special ID card on which a character string is printed leftward is introduced, there is a possibility that an unnecessary warning is presented to the user. As in these examples, in the first exemplary embodiment, there is an issue where the correct answer patterns of an ID card cannot be flexibly updated according to the pattern of an ID card of the user, and therefore, an unnecessary warning is presented.

In a second exemplary embodiment, in view of such an issue, a form is provided in which it is possible to enable and disable warning displays regarding an ID card and update the correct answer pattern information according to the user's request.

The ID card copying processing unit 214 according to the present exemplary embodiment holds warning display disabling information indicating whether warning displays regarding the back surface and the front surface of an ID card are disabled, as inside information in addition to the correct answer pattern information in table 1. Table 2 illustrates the warning display disabling information according to the present exemplary embodiment.

TABLE 2
Warning Display Disabling Information

| Target Surface | Disabling Status |
|---|---|
| Front Surface | Enabled |
| Back Surface | Enabled |

“Target surface” is an attribute indicating a surface as a target regarding which a warning display is enabled or disabled.

In the present exemplary embodiment, either of “front surface” and “back surface” is set.

“Disabling status” is an attribute indicating the disabling status of the warning display regarding the surface as the target. If “enabled” is set, this indicates that the warning display regarding the surface as the target is enabled. If “disabled” is set, this indicates that the warning display regarding the surface as the target is disabled.

For example, the warning display disabling information in table 2 indicates that warning displays regarding both the front surface and the back surface of an ID card are enabled.

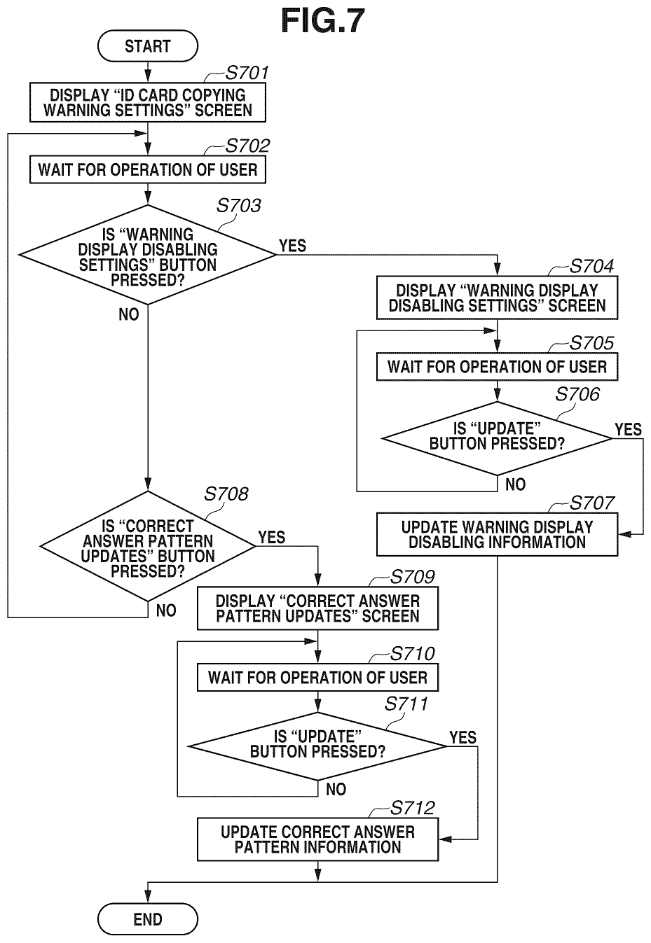

FIG. 7 is a flowchart for describing an ID card copying warning settings update process executed by the image forming apparatus 100 according to the present exemplary embodiment. The flowchart in FIG. 7 is achieved by the CPU 102 of the image forming apparatus 100 reading the programs for achieving the software modules stored in the ROM 104 or the HDD 105 into the RAM 103 and executing the programs.

In step S701, the screen control unit 211 receives an instruction to update ID card copying warning settings from the user, starts the ID card copying application, and displays an “ID card copying warning settings” screen.

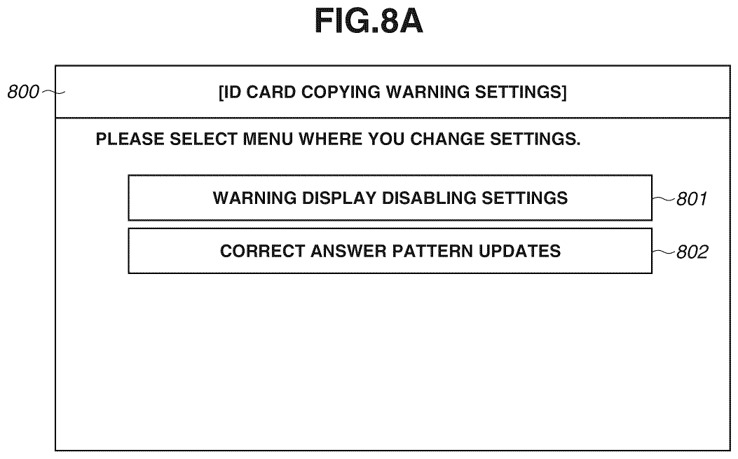

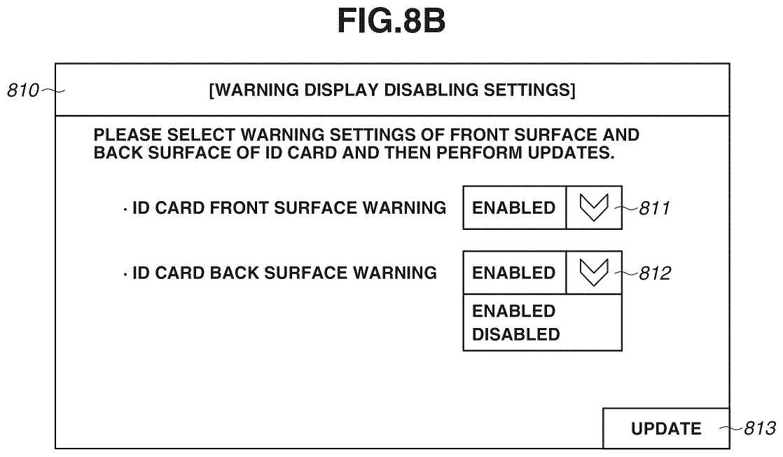

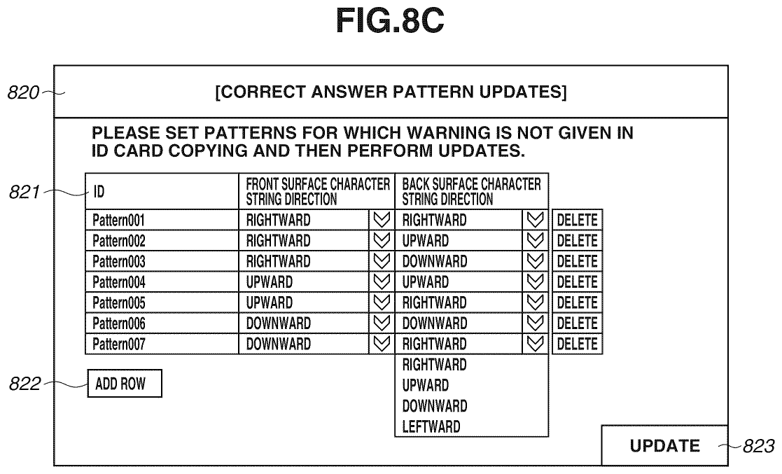

With reference to FIGS. 8A to 8C, screens regarding the updates to the ID card copying warning settings according to the present exemplary embodiment are described.

FIGS. 8A to 8C illustrate examples of the screens regarding the updates to the ID card copying warning settings displayed on the operation unit 107.

An “ID card copying warning settings” screen 800 includes a “warning display disabling settings” button 801 and a “correct answer pattern updates” button 802. The “warning display disabling settings” button 801 is a button for giving an instruction to cause the screen to transition to a “warning display disabling settings” screen. The “correct answer pattern updates” button 802 is a button for giving an instruction to cause the screen to transition to a “correct answer pattern updates” screen. A “warning display disabling settings” screen 810 includes an ID card front surface warning setting menu 811, an ID card back surface warning setting menu 812, and an “update” button 813.

The ID card front surface warning setting menu 811 is a pull-down menu for setting a value indicating whether to warn of an error in the placement of the front surface of an ID card in an ID card copying process.

The initially displayed value of the ID card front surface warning setting menu 811 is the value of “disabling status” of “front surface” as “target surface” in the warning display disabling information in table 2, and the setting value of the ID card front surface warning setting menu 811 can be changed by a selection operation of the user.

The ID card back surface warning setting menu 812 is a pull-down menu for setting a value indicating whether to warn of an error in the placement of the back surface of the ID card in the ID card copying process.

The initially displayed value of the ID card back surface warning setting menu 812 is the value of “disabling status” of “back surface” as “target surface” in the warning display disabling information in table 2, and the setting value of the ID card back surface warning setting menu 812 can be changed by a selection operation of the user.

The “update” button 813 is a button for giving an instruction to update the warning display disabling information in table 2 with the values set in the ID card front surface warning setting menu 811 and the ID card back surface warning setting menu 812 by the user.

A “correct answer pattern updates” screen 820 includes a correct answer pattern setting menu 821, an “add row” button 822, and an “update” button 823. In the correct answer pattern setting menu 821, the information in table 1 as correct answer pattern information regarding the direction of a character string in the ID card copying process is initially displayed. “Front surface character string direction” and “back surface character string direction” are in a pull-down format, and the setting values of “front surface character string direction” and “back surface character string direction” can be changed by a selection operation of the user. By pressing a “delete” button corresponding to each piece of pattern information, a request to cancel the setting can be also be made.

The “add row” button 822 is a button for giving an instruction to add new correct answer pattern information to the correct answer pattern setting menu 821. If the “add row” button 822 is pressed, a single row is added to the correct answer pattern setting menu 821.

The “update” button 823 is a button for giving an instruction to update the correct answer pattern information in table 1 with the values set in the correct answer pattern setting menu 821 by the user.

The description returns to FIG. 7.

In step S702, the ID card copying processing unit 214 waits for an operation of the user through the screen control unit 211.

In step S703, the ID card copying processing unit 214 analyzes an operation of the user through the screen control unit 211 and determines whether the “warning display disabling settings” button 801 in FIG. 8A is pressed. At this time, if it is determined that the “warning display disabling settings” button 801 is pressed (Yes in step S703), the processing proceeds to step S704. If it is determined that the “warning display disabling settings” button 801 is not pressed (No in step S703), the processing proceeds to step S708.

In step S704, the ID card copying processing unit 214 displays the “warning display disabling settings” screen 810 in FIG. 8B through the screen control unit 211. In step S705, the ID card copying processing unit 214 waits for an operation of the user through the screen control unit 211. In step S706, the ID card copying processing unit 214 analyzes an operation of the user through the screen control unit 211 and determines whether the “update” button 813 in FIG. 8B is pressed. At this time, if it is determined that the “update” button 813 is pressed (Yes in step S706), the processing proceeds to step S707. If it is determined that the “update” button 813 is not pressed (No in step S706), the processing returns to step S705.

In step S707, the ID card copying processing unit 214 acquires the values set in the ID card front surface warning setting menu 811 and the ID card back surface warning setting menu 812 by the user through the screen control unit 211. The ID card copying processing unit 214 updates and saves the warning display disabling information in table 2 using the acquired values, and the flowchart ends. As examples of the updates, if the user sets the ID card front surface warning setting menu 811 to “enabled” and the ID card back surface warning setting menu 812 to “disabled”, the warning display disabling information is updated as illustrated in the following table 3.

TABLE 3
Warning Display Disabling Information

| Target Surface | Disabling Status |
|---|---|
| Front Surface | Enabled |
| Back Surface | Disabled |

In step S708, the ID card copying processing unit 214 analyzes an operation of the user through the screen control unit 211 and determines whether the “correct answer pattern updates” button 802 in FIG. 8A is pressed. At this time, if it is determined that the “correct answer pattern updates” button 802 is pressed (Yes in step S708), the processing proceeds to step S709. If it is determined that the “correct answer pattern updates” button 802 is not pressed (No in step S708), the processing returns to step S702.

In step S709, the ID card copying processing unit 214 displays the “correct answer pattern updates” screen 820 in FIG. 8C through the screen control unit 211.

In step S710, the ID card copying processing unit 214 waits for an operation of the user through the screen control unit 211. In step S711, the ID card copying processing unit 214 analyzes an operation of the user through the screen control unit 211 and determines whether the “update” button 823 in FIG. 8C is pressed. At this time, if it is determined that the “update” button 823 is pressed (Yes in step S711), the processing proceeds to step S712. If it is determined that the “update” button 823 is not pressed (No in step S711), the processing returns to step S710.

In step S712, the ID card copying processing unit 214 acquires the values set in the correct answer pattern setting menu 821 by the user through the screen control unit 211. The ID card copying processing unit 214 updates and saves the correct answer pattern information in table 1 using the acquired values, and the flowchart ends. As an example of the updates, if the user sets “back surface character string direction” of “Pattern007” as “ID” in the correct answer pattern setting menu 821 to “leftward”, the correct answer pattern information is updated as illustrated in the following table 4.

TABLE 4
Correct Answer Pattern Information

| | Front Surface Character | Back Surface Character |
|---|---|---|
| ID | String Direction | String Direction |
| Pattern001 | Rightward | Rightward |
| Pattern002 | Rightward | Upward |
| Pattern003 | Rightward | Downward |
| Pattern004 | Upward | Upward |
| Pattern005 | Upward | Rightward |
| Pattern006 | Downward | Downward |
| Pattern007 | Downward | Leftward |

As described above, based on the flowchart in FIG. 7, it is possible to enable and disable warning displays regarding an ID card and update the correct answer pattern information according to the user's request.

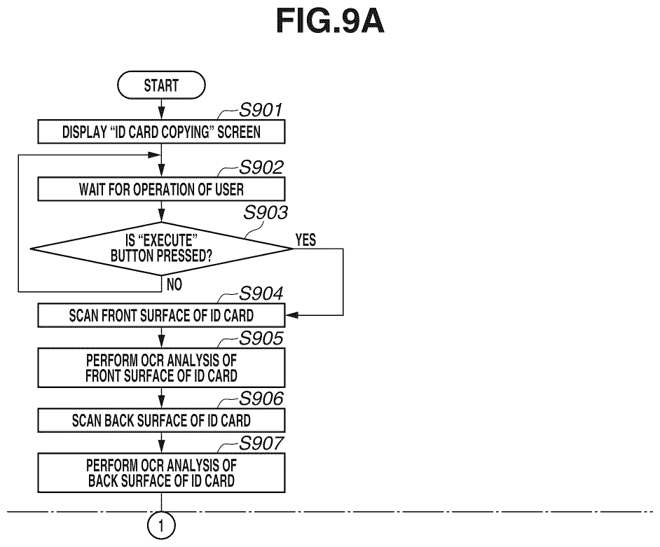

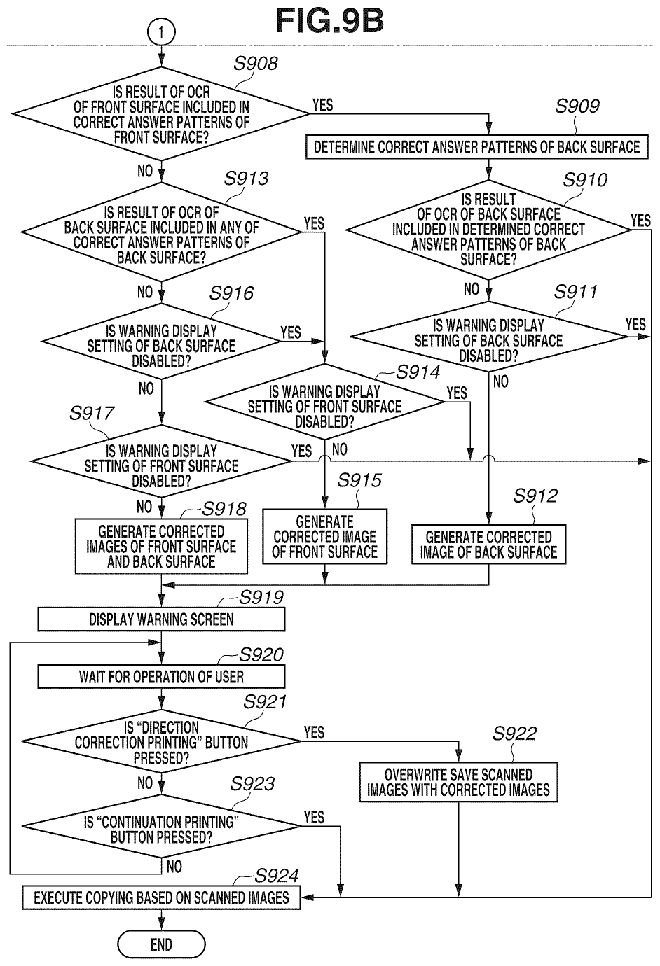

Next, with reference to a flowchart in FIGS. 9A and 9B, a description is given of an ID card copying process to which the warning settings changed by the user are applied.

FIGS. 9A and 9B are a flowchart for describing the processing of the ID card copying function executed by the image forming apparatus 100 according to the present exemplary embodiment.

Steps S901 to S910 are similar to steps S301 to S310, and therefore are not described. As the correct answer pattern information referred to in steps S908 and S910, the latest correct answer pattern information updated by the user is always referred to. In step S911, the ID card copying processing unit 214 acquires the warning display disabling information in table 2 or 3 and determines whether the warning display regarding the back surface is disabled.

At this time, if it is determined that the warning display regarding the back surface is disabled (Yes in step S911), the processing proceeds to step S924. Thus, the warning screen is not displayed. If it is determined that the warning display regarding the back surface is not disabled (No in step S911), the processing proceeds to step S912. In step S919, the ID card copying processing unit 214 displays the warning screen indicating an error in the placement of the back surface of the ID card.

Steps S912 and S913 are similar to steps S311 and S312, and therefore are not described. As the correct answer pattern information referred to in step S913, the latest correct answer pattern information updated by the user is always referred to. In step S914, the ID card copying processing unit 214 acquires the warning display disabling information in table 2 or 3 and determines whether the warning display regarding the front surface is disabled.

At this time, if it is determined that the warning display regarding the front surface is disabled (Yes in step S914), the processing proceeds to step S924. Thus, the warning screen is not displayed. If it is determined that the warning display regarding the front surface is not disabled (No in step S914), the processing proceeds to step S915. In step S919, the ID card copying processing unit 214 displays the warning screen indicating an error in the placement of the front surface of the ID card.

Step S915 is similar to step S313, and therefore is not described. In step S916, the ID card copying processing unit 214 acquires the warning display disabling information in table 2 or 3 and determines whether the warning display regarding the back surface is disabled. At this time, if it is determined that the warning display regarding the back surface is disabled (Yes in step S916), the processing proceeds to step S914. If it is determined that the warning display regarding the back surface is not disabled (No in step S916), the processing proceeds to step S917.

In step S917, the ID card copying processing unit 214 acquires the warning display disabling information in table 2 or 3 and determines whether the warning display regarding the front surface is disabled. At this time, if it is determined that the warning display regarding the front surface is disabled (Yes in step S917), the processing proceeds to step S924. Thus, the warning screen is not displayed. If it is determined that the warning display regarding the front surface is not disabled (No in step S917), the processing proceeds to step S918. In step S919, the ID card copying processing unit 214 displays the warning screen indicating errors in the placement of the front surface and the back surface of the ID card.

Steps S918 to S924 are similar to steps S314 to S320, and therefore are not described.

As described above, based on the flowchart in FIGS. 9A and 9B, it is possible to execute an ID card copying process to which the warning settings changed by the user based on the flowchart in FIGS. 3A and 3B are applied.

As described above, according to the present exemplary embodiment, the user can flexibly update the correct answer patterns of an ID card. Thus, it is possible to prevent an unnecessary warning from being presented and achieve an improvement in usability.

In the first exemplary embodiment, a form has been provided in which an ID card placed at a position specified in advance on the document platen is scanned, and a character string in the scanned image is read by an OCR analysis. However, in a case where the user places an ID card at a position different from the specified position and scans the ID card, a character string in the scanned image cannot be read by an OCR analysis. Thus, an error in the placement cannot be appropriately detected. Thus, in the first exemplary embodiment, there is an issue where if the user places an ID card at a position different from the specified position, ID card copying is performed again or unnecessary printing occurs.

In a third exemplary embodiment, in view of such an issue, a form is provided in which if the result of an OCR analysis is not correctly acquired in a scanned image of an ID card, the user is warned of an error in the placement of the ID card.

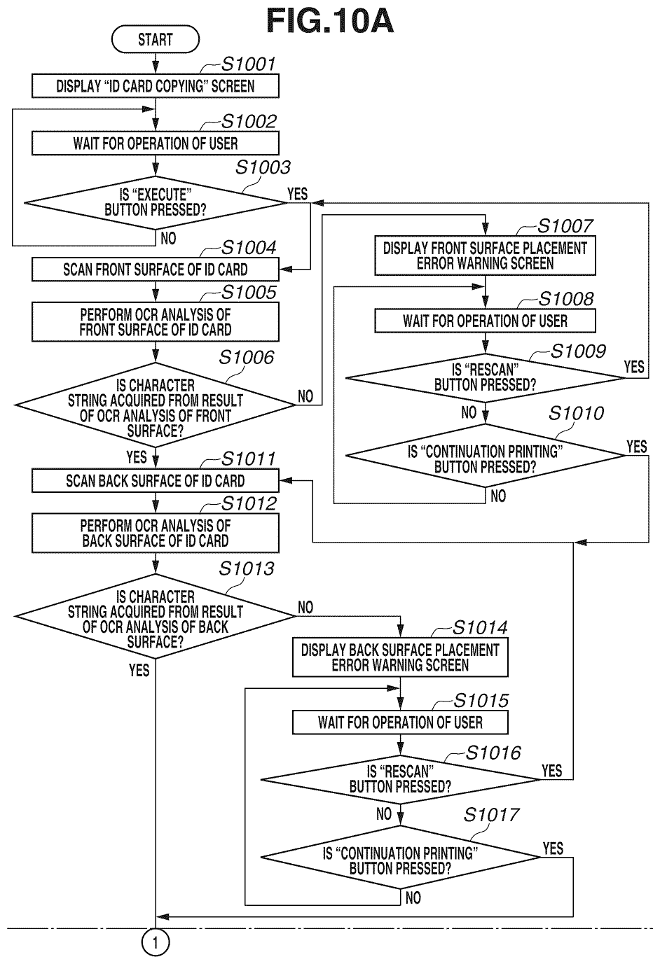

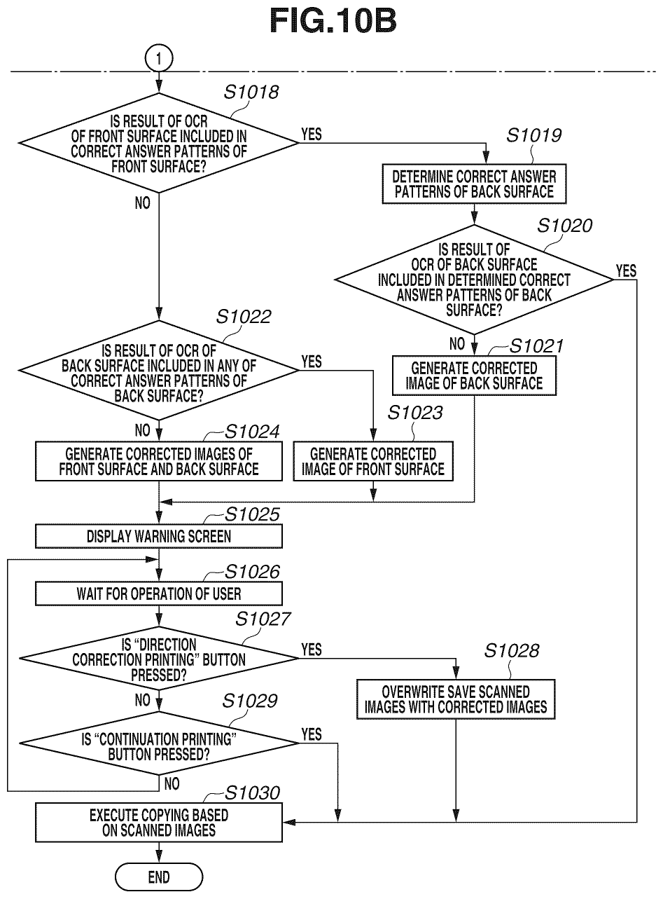

FIGS. 10A and 10B are a flowchart for describing the processing of the ID card copying function executed by the image forming apparatus 100 according to the present exemplary embodiment.

Steps S1001 to S1005 are similar to steps S301 to S305, and therefore are not described.

In step S1006, the ID card copying processing unit 214 determines whether a character string on the front surface of the ID card is acquired in step S1005. At this time, if it is determined that a character string on the front surface of the ID card is acquired (Yes in step S1006), the processing proceeds to step S1011. If it is determined that a character string on the front surface of the ID card is not acquired (No in step S1006), the processing proceeds to step S1007.

In step S1007, the ID card copying processing unit 214 displays a front surface placement error warning screen through the screen control unit 211.

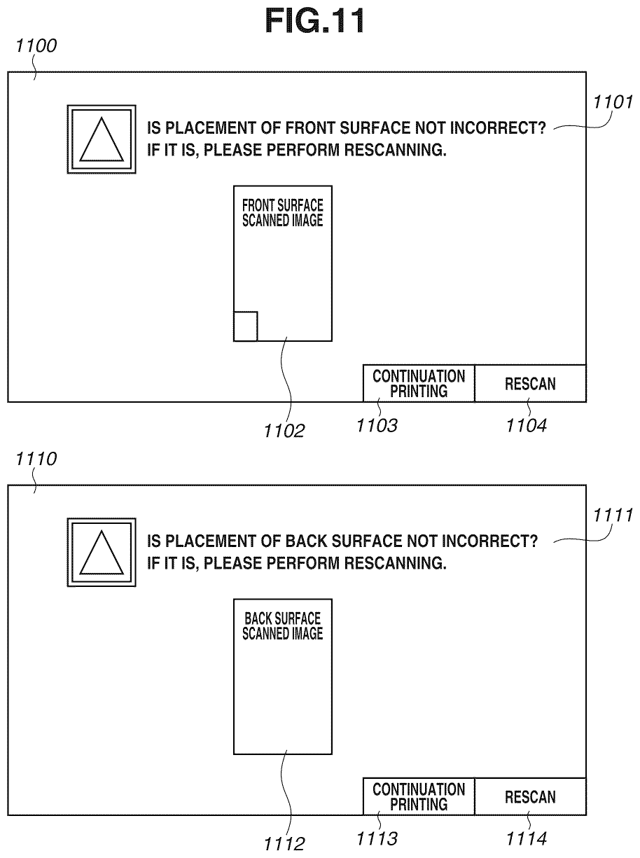

With reference to FIG. 11, screens regarding ID card placement error warnings according to the present exemplary embodiment are described.

FIG. 11 illustrates examples of the screens regarding the ID card placement error warnings displayed on the operation unit 107.

A front surface placement error warning screen 1100 includes a front surface placement error display 1101, a “front surface scanned image” display 1102, a “continuation printing” button 1103, and a “rescan” button 1104.

The front surface placement error display 1101 is an area that displays a notification indicating that there is a possibility that the user does not place the front surface of the ID card at the specified position, and a message suggesting performing rescanning as needed. The “front surface scanned image” display 1102 is an area that displays the scanned image of the front surface of the ID card saved in the RAM 103. In the present exemplary embodiment, a scanned image in a case where only a corner of the front surface of the ID card is included in the specified position is displayed.

The “continuation printing” button 1103 is a button for giving an instruction to execute ID card copying printing without performing rescanning, and ID card copying is executed using the front surface of the ID card saved in the RAM 103. The “rescan” button 1104 is a button for giving an instruction to rescan an image of the front surface of the ID card. A back surface placement error warning screen 1110 includes a back surface placement error display 1111, a “back surface scanned image” display 1112, a “continuation printing” button 1113, and a “rescan” button 1114.

The back surface placement error display 1111 is an area that displays a notification indicating that there is a possibility that the user does not place the back surface of the ID card at the specified position, and a message suggesting performing rescanning as needed. The “back surface scanned image” display 1112 is an area that displays the scanned image of the back surface of the ID card saved in the RAM 103. In the present exemplary embodiment, a scanned image in a case where the back surface of the ID card is not included at all in the specified position is displayed.

Components 1113 and 1114 are similar to the components 1103 and 1104, respectively, and therefore are not described.

The description returns to FIGS. 10A and 10B.

In step S1008, the ID card copying processing unit 214 waits for an operation of the user through the screen control unit 211.

In step S1009, the ID card copying processing unit 214 analyzes an operation of the user through the screen control unit 211 and determines whether the “rescan” button 1104 in FIG. 11 is pressed. At this time, if it is determined that the “rescan” button 1104 is pressed (Yes in step S1009), the processing returns to step S1004. In step S1004, the ID card copying processing unit 214 rescans the front surface of the ID card. If it is determined that the “rescan” button 1104 is not pressed (No in in step S1009), the processing proceeds to step S1010.

In step S1010, the ID card copying processing unit 214 analyzes an operation of the user through the screen control unit 211 and determines whether the “continuation printing” button 1103 in FIG. 11 is pressed. At this time, if it is determined that the “continuation printing” button 1103 is pressed (Yes in step S1010), the processing proceeds to step S1011. If it is determined that the “continuation printing” button 1103 is not pressed (No in step S1010), the processing returns to step S1008.

Steps S1011 and S1012 are similar to steps S306 and S307, and therefore are not described.

In step S1013, the ID card copying processing unit 214 determines whether a character string on the back surface of the ID card is acquired in step S1012. At this time, if it is determined that a character string on the back surface of the ID card is acquired (Yes in step S1013), the processing proceeds to step S1018. If it is determined that a character string on the back surface of the ID card is not acquired (No in step S1013), the processing proceeds to step S1014.

In step S1014, the ID card copying processing unit 214 displays the back surface placement error warning screen 1110 through the screen control unit 211. In step S1015, the ID card copying processing unit 214 waits for an operation of the user through the screen control unit 211.

In step S1016, the ID card copying processing unit 214 analyzes an operation of the user through the screen control unit 211 and determines whether the “rescan” button 1114 in FIG. 11 is pressed. At this time, if it is determined that the “rescan” button 1114 is pressed (Yes in step S1016), the processing returns to step S1011. In step S1011, the ID card copying processing unit 214 rescans the back surface of the ID card. If it is determined that the “rescan” button 1114 is not pressed (No in step S1016), the processing proceeds to step S1017.

In step S1017, the ID card copying processing unit 214 analyzes an operation of the user through the screen control unit 211 and determines whether the “continuation printing” button 1113 in FIG. 11 is pressed. At this time, if it is determined that the “continuation printing” button 1113 is pressed (Yes in step S1017), the processing proceeds to step S1018. If it is determined that the “continuation printing” button 1113 is not pressed (No in step S1017), the processing returns to step S1015.

Steps S1018 to S1030 are similar to steps S308 to S320, and therefore are not described.

As described above, based on the flowchart in FIGS. 10A and 10B, if a character string is not acquired by an OCR analysis, it is possible to warn the user of an error in the placement of an ID card and suggest performing rescanning.

As described above, according to the present exemplary embodiment, also in a case where the user places an ID card at a position different from the specified position, it is possible to prevent ID card copying from being performed again and prevent unnecessary printing.

In a fourth exemplary embodiment, the language set in advance is a first language, and another language is a second language.

In the first exemplary embodiment, a form has been provided in which an OCR analysis is performed using the language set in advance in the image forming apparatus 100, thereby recognizing a character string on an ID card and determining the direction of the character string.

The user, however, often also uses an ID card on which a language different from a language ordinarily used by the user is written. For example, even if the user lives in Japan, a language written on an ID card is often only English. In the first exemplary embodiment, there is an issue where in the copying of an ID card on which a language other than the language set in the image forming apparatus 100 is written as described above, the direction of a character string cannot be correctly determined.

In the fourth exemplary embodiment, in view of such an issue, a form is provided in which if a character string is not recognized by an OCR analysis, a suggestion of executing an OCR analysis using another language is made to the user.

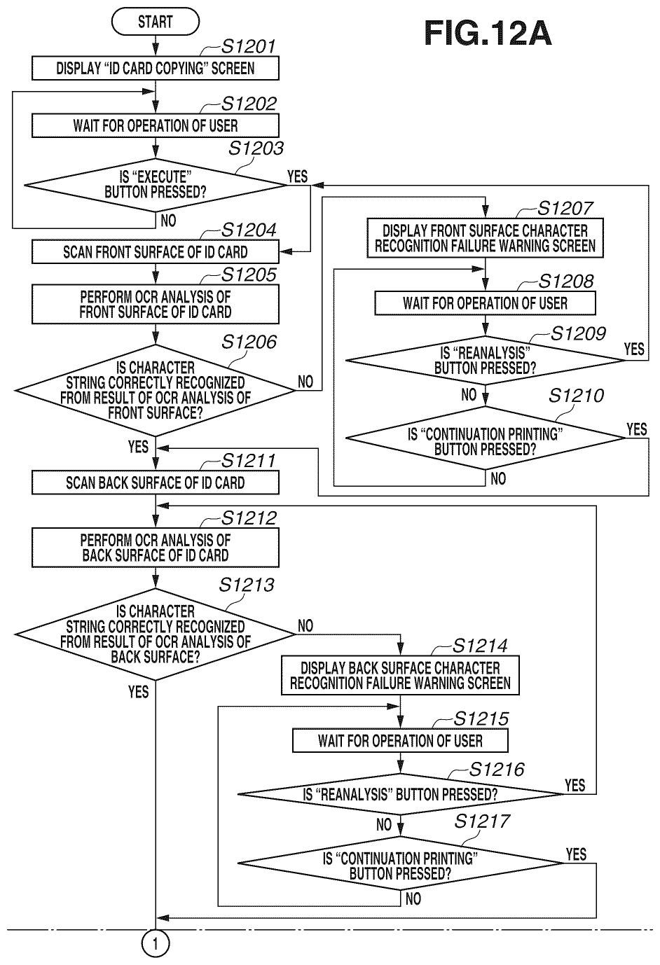

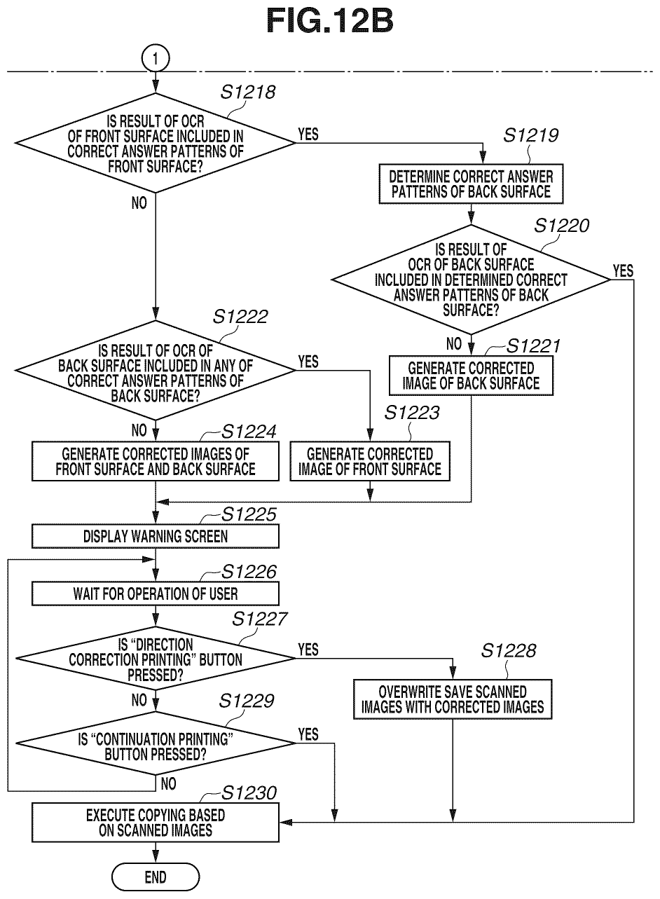

FIGS. 12A and 12B are a flowchart for describing the processing of the ID card copying function executed by the image forming apparatus 100 according to the present exemplary embodiment.

Steps S1201 to S1204 are similar to steps S301 to S304, and therefore are not described.

In step S1205, similarly to step S305, the ID card copying processing unit 214 performs an OCR analysis of the scanned image of the front surface of the ID card and determines the direction of a character string. In the present exemplary embodiment, however, the ID card copying processing unit 214 can also perform the OCR analysis in a specified language. If a language is not particularly specified, then similarly to step S305, the language set in the image forming apparatus 100 is used for the OCR analysis.

In step S1206, the ID card copying processing unit 214 determines whether a character string on the front surface of the ID card is correctly recognized in step S1205. At this time, if it is determined that a character string on the front surface of the ID card is correctly recognized (Yes in step S1206), the processing proceeds to step S1211.

If it is determined that a character string on the front surface of the ID card is not correctly recognized (No in step S1206), the processing proceeds to step S1207. In step S1207, the ID card copying processing unit 214 displays a front surface character recognition failure warning screen through the screen control unit 211.

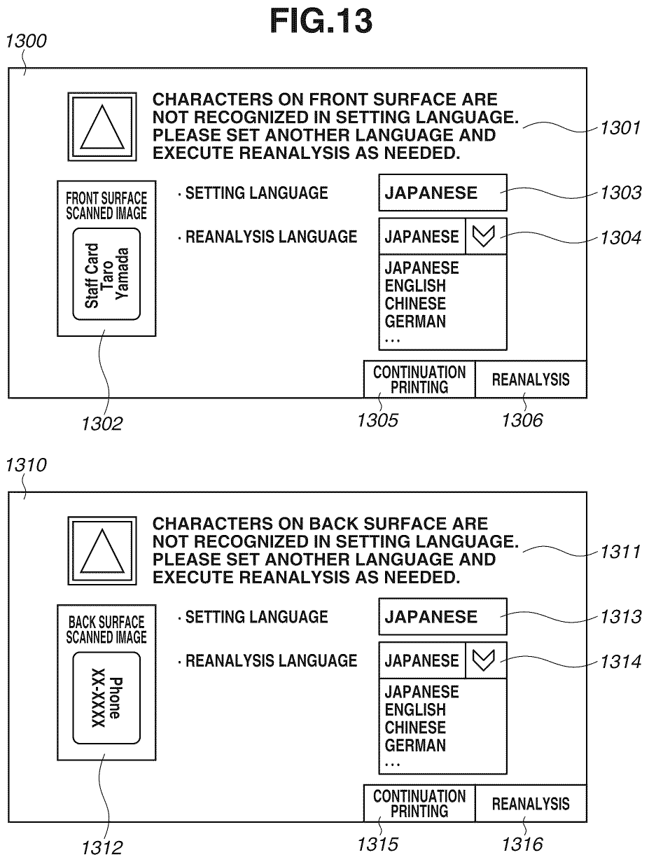

With reference to FIG. 13, screens regarding failures in the recognition of a character string on the ID card according to the present exemplary embodiment are described.

FIG. 13 illustrates examples of the screens regarding failures in the recognition of a character string on the ID card displayed on the operation unit 107.

A front surface character recognition failure screen 1300 includes a front surface character recognition error display 1301, a “front surface scanned image” display 1302, a “setting language” display 1303, a reanalysis language setting menu 1304, a “continuation printing” button 1305, and a “reanalysis” button 1306.

The front surface character recognition error display 1301 is an area that displays a notification indicating that characters in an image of the front surface of the ID card scanned by the user are not recognized in the setting language, and a message suggesting specifying another language and performing an OCR analysis again as needed.

The “front surface scanned image” display 1302 is an area that displays the scanned image of the front surface of the ID card saved in the RAM 103. In the present exemplary embodiment, a scanned image in a case where the front surface of the ID card written in alphabetical characters is scanned by the user is displayed.

The “setting language” display 1303 displays the language when the OCR analysis is performed.

The reanalysis language setting menu 1304 is a pull-down menu for setting a language to be used to perform an OCR analysis again. The “continuation printing” button 1305 is a button for giving an instruction to execute ID card copying printing without performing an OCR analysis again, and ID card copying is executed using the front surface of the ID card saved in the RAM 103.

The “reanalysis” button 1306 is a button for giving an instruction to perform an OCR analysis of the image of the front surface of the ID card again using the language set in the reanalysis language setting menu 1304.

A back surface character recognition failure screen 1310 includes a back surface character recognition error display 1311, a “back surface scanned image” display 1312, a “setting language” display 1313, a reanalysis language setting menu 1314, a “continuation printing” button 1315, and a “reanalysis” button 1316. The back surface character recognition error display 1311 is an area that displays a notification indicating that characters in an image of the back surface of the ID card scanned by the user are not recognized in the setting language, and a message suggesting specifying another language and performing an OCR analysis again as needed.

The “back surface scanned image” display 1312 is an area that displays the scanned image of the back surface of the ID card saved in the RAM 103. In the present exemplary embodiment, a scanned image in a case where the back surface of the ID card written in alphabetical characters is scanned by the user is displayed.

Components 1313 to 1316 are similar to the components 1303 to 1316, respectively, and therefore are not described.

The description returns to FIGS. 12A and 12B.

In step S1208, the ID card copying processing unit 214 waits for an operation of the user through the screen control unit 211. In step S1209, the ID card copying processing unit 214 analyzes an operation of the user through the screen control unit 211 and determines whether the “reanalysis” button 1306 in FIG. 13 is pressed. At this time, if it is determined that the “reanalysis” button 1306 is pressed (Yes in step S1209), the ID card copying processing unit 214 acquires the language specified in the reanalysis language menu 1304 by the user through the screen control unit 211. In step S1205, the ID card copying processing unit 214 executes an OCR analysis again in this language. If it is determined that the “reanalysis” button 1306 is not pressed (No in step S1209), the processing proceeds to step S1210.

In step S1210, the ID card copying processing unit 214 analyzes an operation of the user through the screen control unit 211 and determines whether the “continuation printing” button 1305 in FIG. 13 is pressed. At this time, if it is determined that the “continuation printing” button 1305 is pressed (Yes in step S1210), the processing proceeds to step S1211. If it is determined that the “continuation printing” button 1305 is not pressed (No in step S1210), the processing returns to step S1208.

Step S1211 is similar to step S306, and therefore is not described.

In step S1212, similarly to step S307, the ID card copying processing unit 214 performs an OCR analysis of the scanned image of the back surface of the ID card and determines the direction of a character string. In the present exemplary embodiment, however, the ID card copying processing unit 214 can also perform the OCR analysis in a specified language. If a language is not particularly specified, then similarly to step S307, the language set in the image forming apparatus 100 is used for the OCR analysis. In step S1213, the ID card copying processing unit 214 determines whether a character string on the back surface of the ID card is correctly recognized in step S1212.

At this time, if it is determined that a character string on the back surface of the ID card is correctly recognized (Yes in step S1213), the processing proceeds to step S1218. If it is determined that a character string on the back surface of the ID card is not correctly recognized (No in step S1213), the processing proceeds to step S1214.

In step S1214, the ID card copying processing unit 214 displays the back surface character recognition failure warning screen 1310 through the screen control unit 211.

In step S1215, the ID card copying processing unit 214 waits for an operation of the user through the screen control unit 211. In step S1216, the ID card copying processing unit 214 analyzes an operation of the user through the screen control unit 211 and determines whether the “reanalysis” button 1316 in FIG. 13 is pressed. At this time, if it is determined that the “reanalysis” button 1316 is pressed (Yes in step S1216), the ID card copying processing unit 214 acquires the language specified in the reanalysis language menu 1314 by the user through the screen control unit 211. In step S1212, the ID card copying processing unit 214 executes an OCR analysis again in this language. If it is determined that the “reanalysis” button 1316 is not pressed (No in step S1216), the processing proceeds to step S1217.

In step S1217, the ID card copying processing unit 214 analyzes an operation of the user through the screen control unit 211 and determines whether the “continuation printing” button 1315 in FIG. 13 is pressed. At this time, if it is determined that the “continuation printing” button 1315 is pressed (Yes in step S1217), the processing proceeds to step S1218. If it is determined that the “continuation printing” button 1315 is not pressed (No in step S1217), the processing returns to step S1215.

Steps S1218 to S1230 are similar to steps S308 to S320, and therefore are not described.

As described above, a form is provided in which based on the flowchart in FIGS. 12A and 12B, if a character string is not recognized by an OCR analysis, a suggestion of executing an OCR analysis using another language is made to the user, and it is possible to correctly recognize the character string by an OCR analysis in another language.

As described above, according to the present exemplary embodiment, even in a case where an ID card on which a language other than the language set in the image forming apparatus 100 is written is used for ID card copying, it is possible to prevent ID card copying from being performed again and prevent unnecessary printing.

In the first exemplary embodiment, a form has been provided in which correct answer pattern information regarding an ID card determined in advance is held, and it is determined whether the front surface and the back surface of a scanned ID card match the correct answer pattern information, thereby detecting errors in the placement of the front surface and the back surface. However, the direction of a character string on an ID card has a great feature depending on the country or the language aptitude of the country. There is a character string pattern rarely seen in a certain country, and there is also a character string pattern commonly seen in another country. For example, in Asian countries including Japan, a pattern where a character string on an ID card is written in horizontal writing is seen.

However, in English-speaking countries such as the United States, most ID card designs are written in vertical writing. Thus, it may be redundant to have a rightward character string as a correct answer pattern, and there is a possibility that a failure to give a warning occurs. As described above, there is an issue where with correct answer patterns determined in advance alone, a warning that is normally unnecessary or a failure to give a warning is likely to occur depending on the language.

In a fifth exemplary embodiment, in view of such an issue, a form is provided in which it is possible to change a correct answer pattern of an ID card depending on the language setting of the image forming apparatus 100.

The ID card copying processing unit 214 according to the present exemplary embodiment holds correct answer pattern information with respect to each language setting as inside information. Table 5 illustrates the correct answer pattern information according to the present exemplary embodiment.

TABLE 5

| | | |
|---|---|---|
| | Front Surface Character | Back Surface Character |
| ID | String Direction | String Direction |

Default_Correct Answer Pattern Information

| | | |
|---|---|---|
| Pattern001 | Rightward | Rightward |
| Pattern002 | Rightward | Upward |
| Pattern003 | Rightward | Downward |
| Pattern004 | Upward | Upward |
| Pattern005 | Upward | Rightward |
| Pattern006 | Downward | Downward |
| Pattern007 | Downward | Rightward |

Japanese_Correct Answer Pattern Information

| | | |
|---|---|---|
| Pattern101 | Rightward | Rightward |
| Pattern102 | Rightward | Upward |
| Pattern103 | Rightward | Downward |
| Pattern104 | Upward | Upward |
| Pattern105 | Upward | Rightward |
| Pattern106 | Downward | Downward |
| Pattern107 | Downward | Rightward |

English_Correct Answer Pattern Information

| | | |
|---|---|---|
| Pattern201 | Upward | Upward |
| Pattern202 | Downward | Downward |

In the correct answer pattern information in table 5, correct answer pattern information of which “ID” is “Pattern001” to “Pattern007” is held as default correct answer pattern information. Correct answer pattern information of which “ID” is “Pattern101” to “Pattern107” is held as correct answer pattern information in the language setting of Japanese. Correct answer pattern information of which “ID” is “Pattern201” and “Pattern202” is held as correct answer pattern information in the language setting of English.

In the present exemplary embodiment, the correct answer pattern information corresponds to only the default, Japanese, and English, but is not limited to a particular language. For example, correct answer pattern information in languages such as Chinese and German may be present.

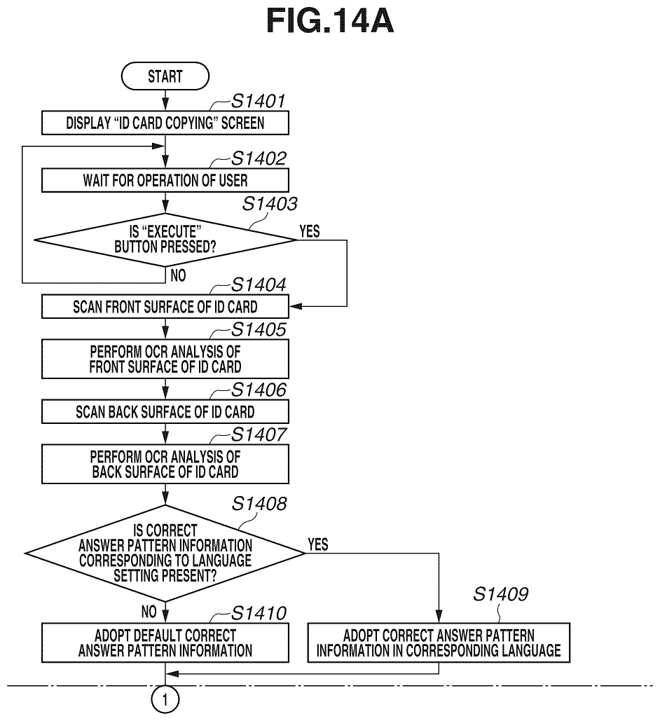

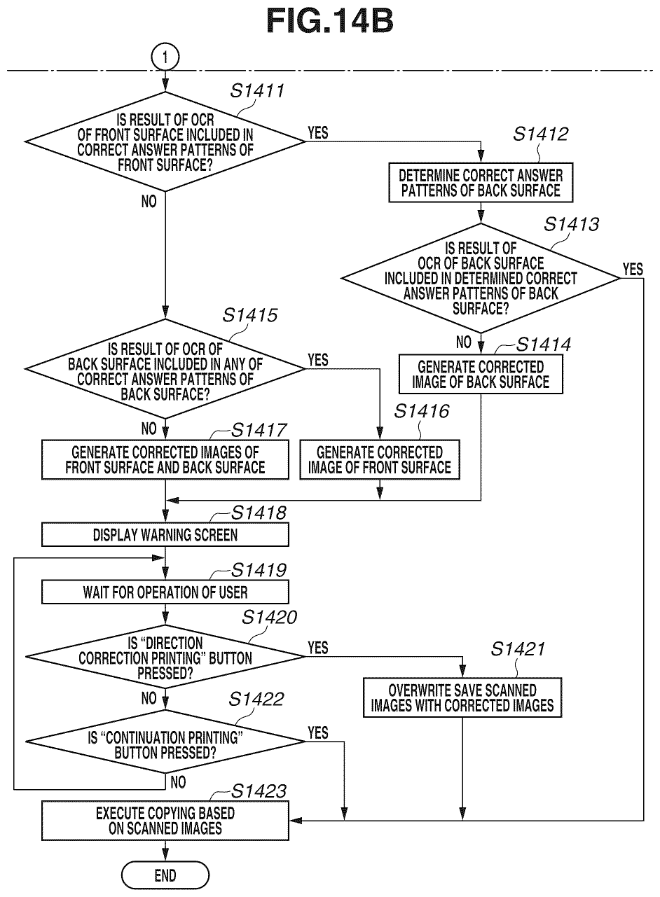

FIGS. 14A and 14B are a flowchart for describing the processing of the ID card copying function executed by the image forming apparatus 100 according to the present exemplary embodiment.

Steps S1401 to S1407 are similar to steps S301 to S307, and therefore are not described.

In step S1408, the ID card copying processing unit 214 acquires the language setting set in the image forming apparatus 100 and determines whether correct answer pattern information in the corresponding language is present in the correct answer pattern information in table 5. At this time, if it is determined that correct answer pattern information in the corresponding language is present (Yes in step S1408), the processing proceeds to step S1409. If it is determined that correct answer pattern information in the corresponding language is not present (No in step S1408), the processing proceeds to step S1410. In step S1409, the ID card copying processing unit 214 stores the correct answer pattern information that is present according to the determination in step S1405 as adopted correct answer pattern information in the RAM 103.

In step S1410, the ID card copying processing unit 214 stores the default correct answer pattern information as adopted correct answer pattern information in the RAM 103. In step S1411, similarly to step S308, the ID card copying processing unit 214 determines whether the direction of the character string on the front surface of the ID card is included in correct answer patterns. However, the correct answer pattern information targets only the adopted correct answer pattern information stored in the RAM 103. In step S1412, similarly to step S309, the ID card copying processing unit 214 determines correct answer pattern information regarding the back surface of the ID card. However, the correct answer pattern information targets only the adopted correct answer pattern information stored in the RAM 103.

Steps S1413 and S1414 are similar to steps S310 and S311, and therefore are not described. In step S1415, similarly to step S312, the ID card copying processing unit 214 determines whether the direction of the character string on the back surface of the ID card is included in correct answer pattern information. However, the correct answer pattern information targets only the adopted correct answer pattern information stored in the RAM 103.

Steps S1416 to S1423 are similar to steps S313 to S320, and therefore are not described.

As described above, based on the flowchart in FIGS. 14A and 14B, it is possible to change a correct answer pattern of an ID card according to the language setting of the image forming apparatus 100.

As described above, according to the present exemplary embodiment, it is also possible to prevent an unnecessary warning or a failure to give a warning regarding ID card copying with various language settings of the image forming apparatus 100.

In the first exemplary embodiment, a form has been provided in which an ID card placed at a position specified in advance on the document platen is scanned, and it is determined whether the scanned image matches correct answer pattern information regarding an ID card determined in advance, thereby detecting an error in the placement. Thus, in the first exemplary embodiment, it is possible to obtain a scanned image in the same direction, and therefore, it is possible to detect an error in the placement with high accuracy using correct answer pattern information determined in advance alone.

However, there is an issue where in a case where an ID card copying function in which the user can optionally change the orientation of the scanning position of an ID card on the document platen is provided, the vertical and horizontal directions of a character string to be acquired switch. Thus, it is not possible to detect an error in the placement of an ID card with high accuracy using correct answer pattern information regarding an ID card determined in advance alone.

For example, a case where correct answer pattern information that allows only a card in vertical writing is held is based on the premise that a scanned document in a portrait orientation corresponds to only a correct answer pattern indicating upward or downward for both the front surface and the back surface. However, in a case where a document can be scanned in a landscape orientation, it is not possible to detect an error in the placement of the document with high accuracy unless the document corresponds to only a correct answer pattern indicating rightward.

In a sixth exemplary embodiment, in view of such an issue, a form is provided in which it is possible to change correct answer pattern information regarding an ID card depending on the specified orientation of the placement of an ID card.

The ID card copying processing unit 214 according to the present exemplary embodiment holds correct answer pattern information with respect to each orientation of the placement of an ID card as inside information. Table 6 illustrates the correct answer pattern information according to the present exemplary embodiment.

TABLE 6

| | | |
|---|---|---|
| | Front Surface Character | Back Surface Character |
| ID | String Direction | String Direction |

Portrait Placement_Correct Answer Pattern Information

| | | |
|---|---|---|
| Pattern001 | Upward | Upward |
| Pattern002 | Downward | Downward |

Landscape Placement_Correct Answer Pattern Information

| | | |
|---|---|---|
| Pattern101 | Rightward | Rightward |

In the correct answer pattern information in table 6, correct answer pattern information of which “ID” is “Pattern001” and “Pattern002” is held as portrait placement correct answer pattern information. Correct answer pattern information of which “ID” is “Pattern101” is held as landscape placement correct answer pattern information.

In the present exemplary embodiment, the correct answer pattern information corresponds to only the portrait placement and the landscape placement, but is not limited to the orientation of particular placement. For example, a correct answer pattern corresponding to a central position may be present.

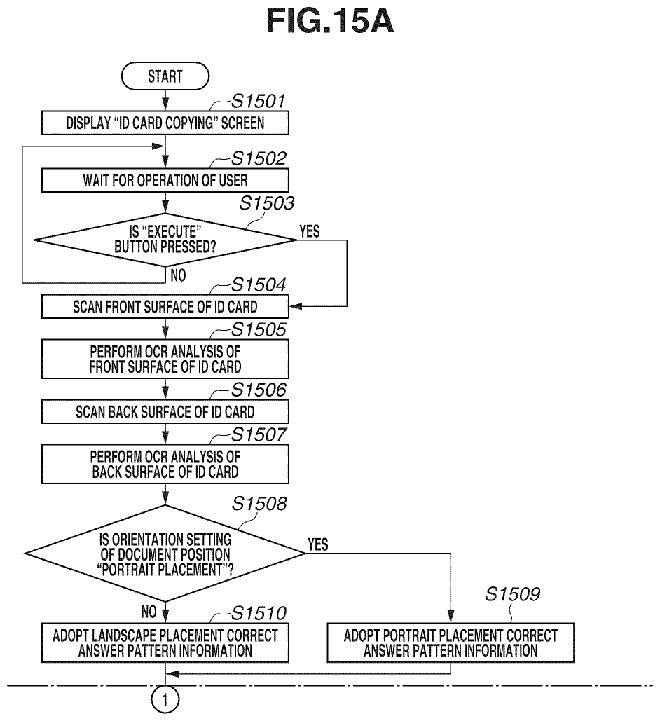

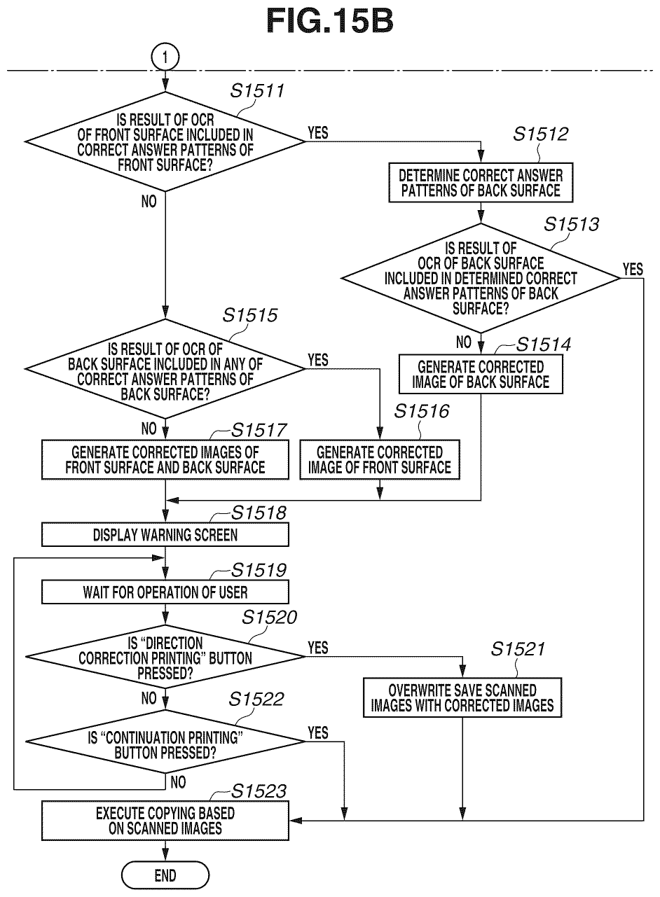

FIGS. 15A and 15B are a flowchart for describing the processing of the ID card copying function executed by the image forming apparatus 100 according to the present exemplary embodiment.

In step S1501, the screen control unit 211 receives an instruction to perform an ID card copying process from the user, starts the ID card copying application, and displays an “ID card copying” screen.

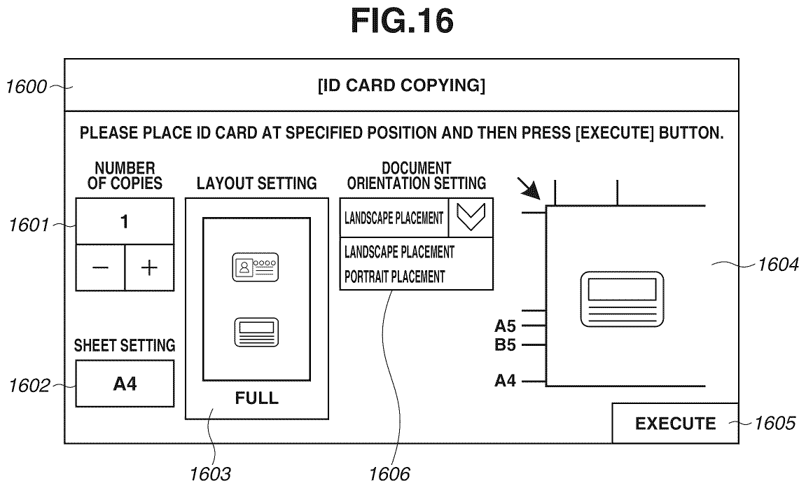

With reference to FIG. 16, the “ID card copying” screen is described.

FIG. 16 illustrates an example of the “ID card copying” screen displayed on the operation unit 107.

An “ID card copying” screen 1600 includes a number-of-copies setting 1601, a sheet size setting 1602, a layout setting 1603, a guide display 1604, an “execute” button 1605, and a document orientation setting menu 1606.

Components 1601 to 1603 are similar to the components 401 to 403, respectively, and therefore are not described.

The guide display 1604 is a display for describing at which position on the document platen an ID card is to be placed. The display is updated based on the value set in the document orientation setting menu 1606. The guide display 1604 according to the present exemplary embodiment is a guide display when “landscape placement” is set in the document orientation setting menu 1606, and is a guide display that enables the user to understand that a document is placed in landscape placement.

The document orientation setting menu 1606 is a pull-down menu for setting the orientation of the ID card when the ID card is placed on the document platen. The setting value of the document orientation setting menu 1606 can be changed by a selection operation of the user. In the present exemplary embodiment, “portrait placement” and “landscape placement” can be selected.

The description returns to FIGS. 15A and 15B.

Steps S1502 to S1507 are similar to steps S302 to S307, and therefore are not described.

In step S1508, the ID card copying processing unit 214 acquires the value set in the document orientation setting menu 1606 in FIG. 16 through the screen control unit 211 and determines whether the value is “portrait placement”. At this time, if it is determined that the orientation setting of the document position is “portrait placement” (Yes in step S1508), the processing proceeds to step S1509. If it is determined that the orientation setting of the document position is not “portrait placement” (No in step S1508), the processing proceeds to step S1510.

In step S1509, the ID card copying processing unit 214 stores the portrait placement correct answer pattern information in table 6 as adopted correct answer pattern information in the RAM 103. In step S1510, the ID card copying processing unit 214 stores the landscape placement correct answer pattern information in table 6 as adopted correct answer pattern information in the RAM 103.

In step S1511, similarly to step S308, the ID card copying processing unit 214 determines whether the direction of the character string on the front surface of the ID card is included in correct answer patterns. However, the correct answer pattern information targets only the adopted correct answer pattern information stored in the RAM 103. In step S1512, similarly to step S309, the ID card copying processing unit 214 determines correct answer pattern information regarding the back surface of the ID card. However, the correct answer pattern information targets only the adopted correct answer pattern information stored in the RAM 103.

Steps S1513 and S1514 are similar to steps S310 and S311, and therefore are not described. In step S1515, similarly to step S312, the ID card copying processing unit 214 determines whether the direction of the character string on the back surface of the ID card is included in correct answer pattern information. However, the correct answer pattern information targets only the adopted correct answer pattern information stored in the RAM 103. Steps S1516 to S1523 are similar to steps S313 to S320, and therefore are not described.

As described above, based on the flowchart in FIGS. 15A and 15B, it is possible to change correct answer pattern information regarding an ID card depending on the specified orientation of the placement of an ID card.

As described above, according to the present exemplary embodiment, also in a case where an ID card copying function in which the user can optionally change the orientation of the scanning position of an ID card on the document platen is provided, it is possible to detect an error in the placement of an ID card with high accuracy.

### Other Exemplary Embodiments

As described above, in each of the exemplary embodiments, a case has been described where the directions of the front surface and the back surface of an ID card match each other (are shifted at 0 degrees) or are shifted in 90-degree units.

If, however, the user themselves places an ID card on the document platen, it is extremely rare that the front surface and the back surface of the ID card correspond to such a case.

Accordingly, a description is given below of the case of a shift that falls short of a shift in 90-degree units.

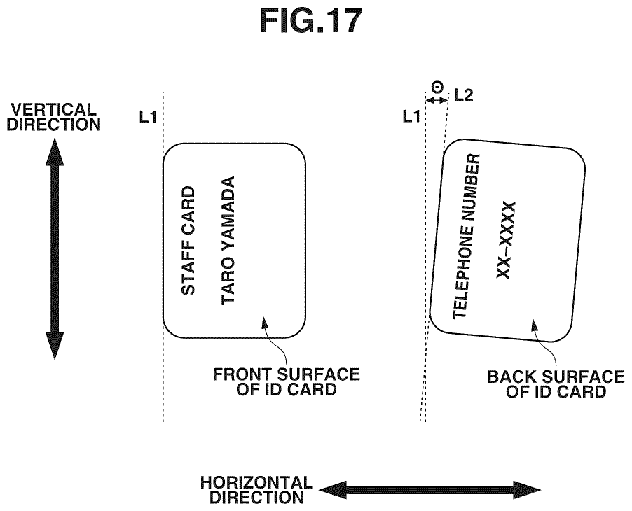

FIGS. 17 to 19 are diagrams illustrating images obtained by scanning the front surface and the back surface of an ID card.

FIGS. 17 to 19 illustrate shifts in the angles of the ID card and predetermined references in a case where the front surface and the back surface are read. FIGS. 17 to 19 may each illustrate respective images in a case where the front surface and the back surface are read. Alternatively, FIGS. 17 to 19 may each illustrate a single image formed based on images obtained by reading the front surface and the back surface.

FIG. 17 is a diagram illustrating the difference between the directions of the ID card using outer edge portions of the front surface and the back surface of the ID card as predetermined references and illustrates an example where the tangents to the outer edge portions of the front surface and the back surface of the ID card are defined as L1 (the front surface) and L2 (the back surface), respectively, and the difference between L1 and L2 is θ.

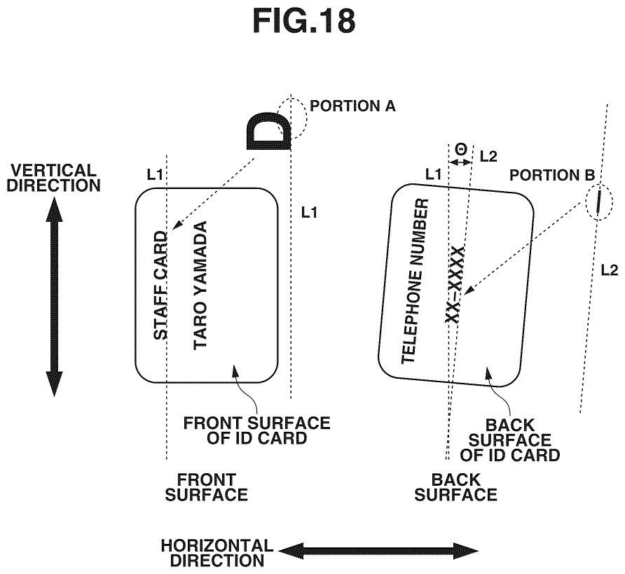

In FIG. 18, using parts of character strings included in the images read from the front surface and the back surface of the ID card as predetermined references, these parts are defined as L1 (the front surface) and L2 (the back surface), respectively. In a case where a part of a character is used as a predetermined reference, for example, as in a portion A in FIG. 18, a portion composed of a straight line among portions composing the character may be extracted. As in a portion B in FIG. 18, an alphanumeric character or a mark such as a hyphen may be extracted. In a case where an outer edge portion of the ID card is composed mainly of a straight line, a part of a character of which the direction approximately matches that of the outer edge portion may be extracted. Further, a straight line connecting the centers of gravity of characters may be extracted.

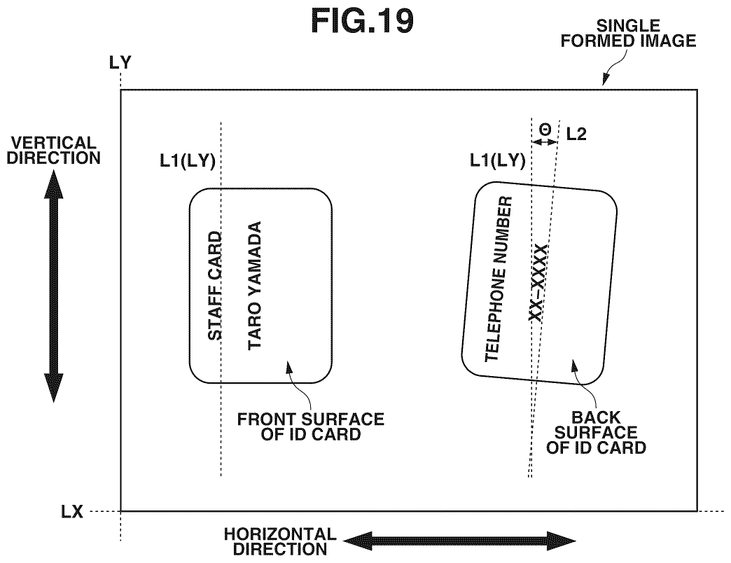

Further, FIG. 19 illustrates an example where, using an outer edge portion LY of a single image formed by the scanner 111 reading the front surface and the back surface of the ID card as a predetermined reference, the difference between the angles of the front surface and the back surface is θ (the angle between L1 and LY and the angle between L2 and LY are calculated, and the difference between the angles is obtained).

As described above, in all of L1, L2, and LY, predetermined references have been provided in the vertical direction in the drawings, and the difference between the directions of the front surface and the back surface of the ID card have been described. However, the difference between the directions of the front surface and the back surface may be calculated using the horizontal direction in the drawings (outer edge portions in the horizontal direction of the card, parts in the horizontal direction of the characters, or an outer edge portion LX in the horizontal direction of the single image formed by the scanner 111 reading the front surface and the back surface of the ID card) as predetermined references, or may be calculated by mixing the vertical and horizontal directions. An outer edge portion of a reading frame portion of the document platen of the scanner 111 or a reading guide portion as a guide for reading may be used as a predetermined reference.

The document platen may be replaced with an automatic document feeder (ADF). If there is no problem with the reading of a reading sheet, a method or a mechanism for reading the reading sheet does not particularly matter, either. For example, a sheet feeding method may be upper surface sheet feeding, back surface sheet feeding, or sheet feeding from a cassette.

Next, a description is given below of processing according to the present disclosure in a case where the front surface and back surface of an ID card are scanned and the difference between the directions of the front surface and back surface is small (the difference between the angles of the front surface and back surface is θ).

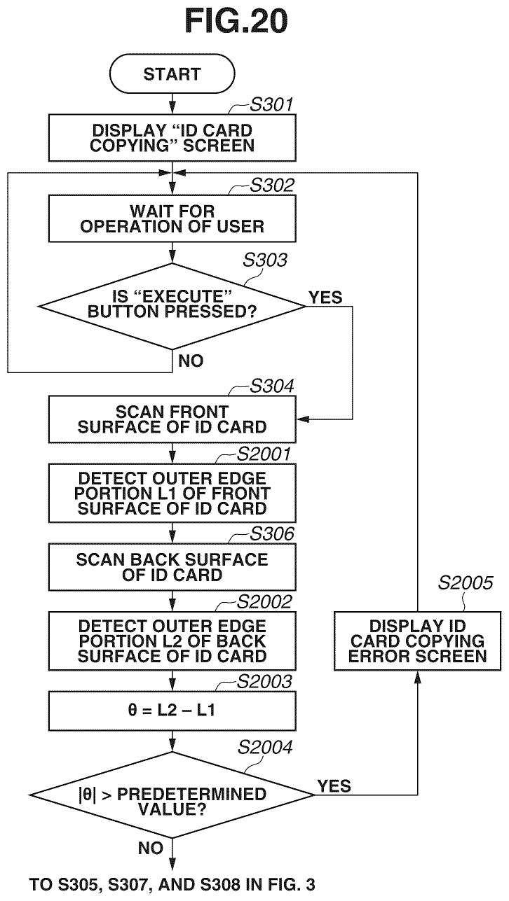

FIG. 20 is a flowchart illustrating the processing according to the present disclosure in a case where the front surface and the back surface of an ID card are scanned.

Processes similar to (having the same step numbers as) those in the flowchart in FIGS. 3A and 3B are not described.

In step S2001, the ID card copying processing unit 214 detects an outer edge portion L1 (FIG. 17) of the front surface of the ID card.

In step S2002, the ID card copying processing unit 214 detects an outer edge portion L2 (FIG. 17) of the back surface of the ID card. Further, in step S2003, the ID card copying processing unit 214 calculates an angle θ between the outer edge portions L2 and L1. Then, in step S2004, if the absolute value of the angle θ goes outside a predetermined range (exceeds a predetermined value) (deviates from the predetermined range) (Yes in step S2004), the processing proceeds to step S2005. If the absolute value of the angle θ falls within the predetermined range (is less than or equal to the predetermined value) (No in step S2004), the processing proceeds to step S308 via steps S305 and S307 in FIGS. 3A and 3B.

The predetermined value may be determined in a range that does not influence the OCR analyses in steps S305 and S307, or in a range that does not influence the comparison with the correct answer pattern information in step S308. For example, in view of the accuracy of the placement of an ID card on the document platen of the scanner 111 by the user, the predetermined value may be set to about 10 degrees or less.

Further, an example has been illustrated where the vertical direction and the vertical direction of the ID card or the horizontal direction and the horizontal direction of the ID card are matched to each other. This processing, however, can also be similarly applied to a case where a large rotation (e.g., a rotation by 90, 180, or 270 degrees) of the back surface relative to the front surface corresponds to correct answer pattern information. In such a case, using the correct answer pattern information as a predetermined reference, the difference from the correct answer pattern information may be calculated as θ.

### Yet Other Exemplary Embodiments

The present disclosure can also be achieved by the process of supplying a program for achieving one or more functions of the above exemplary embodiments to a system or an apparatus via a network or a storage medium, and of causing one or more processors of a computer of the system or the apparatus to read and execute the program. The present disclosure can also be achieved by a circuit (e.g., an application-specific integrated circuit (ASIC)) for achieving the one or more functions.

According to the present disclosure, a display unit that displays information regarding whether the direction of a reading sheet relative to a predetermined reference such as a document platen of an image forming apparatus is excellent or poor is provided. Thus, images of a plurality of reading sheets formed in a single image match each other in up, down, left, and right or vertical and horizontal relationships desired by a user.

The disclosure of the above exemplary embodiments includes the following configurations.

### Configuration 1

An image forming apparatus includes a reading unit including a document platen, the reading unit configured to read one or more reading sheets each including a first surface and a second surface, an image forming unit configured to form a single image based on images obtained by reading the first surface and the second surface, and a display unit configured to, based on a direction of a character string obtained from the image obtained by the reading unit reading the first surface and a direction of a character string obtained from the image obtained by the reading unit reading the second surface, display information regarding whether a direction of the reading sheet relative to a predetermined reference is excellent or poor.

### Configuration 2

There is provided the image forming apparatus according to configuration 1, wherein in a case where a deviation of the direction of the reading sheet from the predetermined reference goes outside a predetermined range, the display unit displays information indicating that the direction of the reading sheet relative to the predetermined reference is poor.

### Configuration 3

There is provided the image forming apparatus according to configuration 1, wherein the predetermined reference is the document platen.

### Configuration 4

There is provided the image forming apparatus according to configuration 1, wherein the first surface and the second surface of the reading sheet are a front surface and a back surface of a single reading sheet.

### Configuration 5

There is provided the image forming apparatus according to configuration 1, wherein the first surface and the second surface of the reading sheet are a first reading sheet and a second reading sheet different from the first reading sheet.

### Configuration 6

There is provided the image forming apparatus according to configuration 1, further comprising a printing unit configured to print results of reading the first surface and the second surface.

### Configuration 7

There is provided the image forming apparatus according to configuration 1, further comprising a correction unit configured to correct an image,
wherein in a case where the direction of the reading sheet relative to the predetermined reference in a case where the reading unit reads the second surface is poor, the correction unit corrects the image obtained by reading the second surface.

### Configuration 8

There is provided the image forming apparatus according to configuration 1, further comprising a nullification unit configured to, between an excellent state and a poor state of the direction of the reading sheet relative to the predetermined reference in a case where the reading unit reads the second surface, nullify the poor state,
wherein in a case where the nullification unit nullifies the poor state, information regarding whether a result of reading the second surface is excellent or poor is updated.

### Configuration 9

There is provided the image forming apparatus according to configuration 1, wherein in a case where the character string on the first surface or the second surface is not recognized based on a first language, a suggestion of reading the first surface or the second surface based on a second language different from the first language is displayed.

### Configuration 10

There is provided the image forming apparatus according to configuration 1, wherein based on a result of performing an optical character recognition (OCR) analysis of the image obtained by reading the first surface or the second surface, information regarding whether a result of reading the second surface is excellent or poor is displayed.

### Configuration 11

An image forming apparatus includes a reading unit including a document platen, the reading unit configured to read one or more reading sheets each including a first surface and a second surface, an image forming unit configured to form a single image based on images obtained by reading the first surface and the second surface, a correction unit configured to, based on a direction of a character string obtained from the image obtained by the reading unit reading the first surface and a direction of a character string obtained from the image obtained by the reading unit reading the second surface, correct the image obtained by reading the second surface, and a printing unit configured to print the first surface and the corrected image obtained by reading the second surface.

### Configuration 12

An image forming apparatus includes a reading unit including a document platen, the reading unit configured to read one or more reading sheets each including a first surface and a second surface, an image forming unit configured to form a single image based on images obtained by reading the first surface and the second surface, and a display unit including a pattern table having a set of a direction of a character string obtained from an image obtained by the reading unit reading the first surface and a direction of a character string obtained from an image obtained by the reading unit reading the second surface, the display unit configured to, based on a direction of a character string obtained from the image obtained by reading the first surface, a direction of a character string obtained from the image obtained by reading the second surface, and the pattern table, display information regarding whether a direction of the reading sheet relative to a predetermined reference is excellent or poor.

### Method 1

A control method for controlling an image forming apparatus includes reading one or more reading sheets each including a first surface and a second surface, forming a single image based on images obtained by reading the first surface and the second surface, based on a direction of a character string obtained from the image obtained by reading the first surface and a direction of a character string obtained from the image obtained by reading the second surface, correcting the image obtained by reading the second surface, and printing the first surface and the corrected image obtained by reading the second surface.

### Recording Medium 1

There is provided a non-transitory computer readable recording medium storing a program for causing a computer to execute a control method for controlling an image forming apparatus. The control method includes reading one or more reading sheets each including a first surface and a second surface, forming a single image based on images obtained by reading the first surface and the second surface, based on a direction of a character string obtained from the image obtained by reading the first surface and a direction of a character string obtained from the image obtained by reading the second surface, correcting the image obtained by reading the second surface, and printing the first surface and the corrected image obtained by reading the second surface.

It is possible to cause images of a plurality of reading sheets formed in a single image to match each other in up, down, left, and right or vertical and horizontal relationships desired by a user, by displaying information regarding whether a direction of a reading sheet is excellent or poor.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-026123, filed Feb. 26, 2024, which is hereby incorporated by reference herein in its entirety.

What is claimed is:

1. An image forming apparatus comprising:
a reading unit including a document platen, the reading unit configured to read one or more reading sheets each including a first surface and a second surface;
an image forming unit configured to form a single image based on images obtained by reading the first surface and the second surface; and
a display unit configured to, based on a direction of a character string obtained from the image obtained by the reading unit reading the first surface and a direction of a character string obtained from the image obtained by the reading unit reading the second surface, display information regarding whether a direction of the reading sheet relative to a predetermined reference is excellent or poor.

2. The image forming apparatus according to claim 1, wherein in a case where a deviation of the direction of the reading sheet from the predetermined reference goes outside a predetermined range, the display unit displays information indicating that the direction of the reading sheet relative to the predetermined reference is poor.

3. The image forming apparatus according to claim 1, wherein the predetermined reference is the document platen.

4. The image forming apparatus according to claim 1, wherein the first surface and the second surface of the reading sheet are a front surface and a back surface of a single reading sheet.

5. The image forming apparatus according to claim 1, wherein the first surface and the second surface of the reading sheet are a first reading sheet and a second reading sheet different from the first reading sheet.

6. The image forming apparatus according to claim 1, further comprising a printing unit configured to print results of reading the first surface and the second surface.

7. The image forming apparatus according to claim 1, further comprising a correction unit configured to correct an image,
wherein in a case where the direction of the reading sheet relative to the predetermined reference in a case where the reading unit reads the second surface is poor, the correction unit corrects the image obtained by reading the second surface.

8. The image forming apparatus according to claim 1, further comprising a nullification unit configured to, between an excellent state and a poor state of the direction of the reading sheet relative to the predetermined reference in a case where the reading unit reads the second surface, nullify the poor state,
wherein in a case where the nullification unit nullifies the poor state, information regarding whether a result of reading the second surface is excellent or poor is updated.

9. The image forming apparatus according to claim 1, wherein in a case where the character string on the first surface or the second surface is not recognized based on a first language, a suggestion of reading the first surface or the second surface based on a second language different from the first language is displayed.

10. The image forming apparatus according to claim 1, wherein based on a result of performing an optical character recognition (OCR) analysis of the image obtained by reading the first surface or the second surface, information regarding whether a result of reading the second surface is excellent or poor is displayed.

11. An image forming apparatus comprising:
a reading unit including a document platen, the reading unit configured to read one or more reading sheets each including a first surface and a second surface;
an image forming unit configured to form a single image based on images obtained by reading the first surface and the second surface;
a correction unit configured to, based on a direction of a character string obtained from the image obtained by the reading unit reading the first surface and a direction of a character string obtained from the image obtained by the reading unit reading the second surface, correct the image obtained by reading the second surface; and
a printing unit configured to print the first surface and the corrected image obtained by reading the second surface.

12. An image forming apparatus comprising:
a reading unit including a document platen, the reading unit configured to read one or more reading sheets each including a first surface and a second surface;
an image forming unit configured to form a single image based on images obtained by reading the first surface and the second surface; and
a display unit including a pattern table having a set of a direction of a character string obtained from an image obtained by the reading unit reading the first surface and a direction of a character string obtained from an image obtained by the reading unit reading the second surface, the display unit configured to, based on a direction of a character string obtained from the image obtained by reading the first surface, a direction of a character string obtained from the image obtained by reading the second surface, and the pattern table, display information regarding whether a direction of the reading sheet relative to a predetermined reference is excellent or poor.

13. A control method for controlling an image forming apparatus, the control method comprising:
reading one or more reading sheets each including a first surface and a second surface;
forming a single image based on images obtained by reading the first surface and the second surface;
based on a direction of a character string obtained from the image obtained by reading the first surface and a direction of a character string obtained from the image obtained by reading the second surface, correcting the image obtained by reading the second surface; and
printing the first surface and the corrected image obtained by reading the second surface.

14. A non-transitory computer readable recording medium storing a program for causing a computer to execute a control method for controlling an image forming apparatus, the control method comprising:
reading one or more reading sheets each including a first surface and a second surface;
forming a single image based on images obtained by reading the first surface and the second surface;
based on a direction of a character string obtained from the image obtained by reading the first surface and a direction of a character string obtained from the image obtained by reading the second surface, correcting the image obtained by reading the second surface; and
printing the first surface and the corrected image obtained by reading the second surface.
